(19) United States
(12) Patent Application Publication
(10) Pub. No.: US 2024/0101829 A1
(43) Pub. Date: Mar. 28, 2024

(54) COMPOSITE PARTICLES AND METHOD FOR PRODUCING COMPOSITE PARTICLES

(71) Applicant: DIC Corporation, Tokyo (JP)

(72) Inventors: Meng Li, Qingdao (CN); Takanori Watanabe, Sakura-shi (JP); Jianjun Yuan, Sakura-shi (JP); Shaowei Yang, Qingdao (CN); Xuan Li, Qingdao (CN); Wei Zhao, Qingdao (CN); Jian Guo, Qingdao (CN)

(73) Assignee: DIC Corporation, Tokyo (JP)

(21) Appl. No.: 18/271,565

(22) PCT Filed: Dec. 31, 2021
(86) PCT No.: PCT/CN2021/143679

§ 371 Date: Jul. 10, 2023

(30) Foreign Application Priority Data
Jan. 13, 2021 (WO) PCT/CN2021/071384

(51) Int. Cl. C09C 1/00; C08K 9/02; C09D 5/36; C09D 7/40; C09D 7/62; C09D 11/037

(52) U.S. Cl. CPC C09C 1/0051; C08K 9/02; C09C 1/0021; C09C 1/0024; C09D 5/36; C09D 7/62; C09D 7/70; C09D 11/037; C01P 2002/52; C01P 2004/03; C01P 2004/24; C01P 2004/84; C09C 2200/1016; C09C 2200/308; C09C 2220/103; C09C 2220/106

(57) ABSTRACT

Composite particles of the present invention include alumina particles and an inorganic coating disposed on a surface of the alumina particles, the alumina particles containing molybdenum (Mo), the inorganic coating including a composite metal oxide.

### TECHNICAL FIELD

The present invention relates to composite particles and, a method for producing the composite particles. In particular, the present invention relates to composite particles including alumina particles provided with a coating.

Priority is claimed on International Application No. PCT/CN2021/071384, filed on Jan. 13, 2021, the content of which is incorporated herein by reference.

### BACKGROUND ART

Alumina particles, which are an inorganic filler, are used in various applications. Among others, flaky alumina particles, which have a high aspect ratio, have particularly excellent thermal properties, optical properties, and the like compared with spherical alumina particles, and, therefore, a further improvement in the performance of flaky alumina particles is desired.

In the related art, various flaky alumina particles having a shape characteristic, such as a particular major dimension or thickness, are known; such a characteristic was designed to improve the above-described inherent properties of flaky alumina particles, dispersibility, and the like (PTL 1 and 2). Furthermore, production methods in which a shape of flaky alumina particles is controlled to increase an aspect ratio thereof are known. Examples of the production methods include a method in which hydrothermal synthesis is performed with the addition of a phosphoric acid compound, which is used as a shape control agent (PTL 3); and a method in which firing is performed with the addition of a silicofluoride (PTL 4).

In addition, a method for producing flaky alumina is known in which, in the production of the flaky alumina, silicon or a silicon compound that contains elemental silicon is used as a crystallinity control agent (PTL 5).

As coated alumina particles, alumina particles having a surface uniformly covered with zirconia nanoparticies are known; the alumina particles can be obtained by covering a surface of alumina particles having an average particle diameter of 0.1 μm or greater with zirconia nanoparticles having an average particle diameter of 100 nm or less (PTL 6).

Furthermore, as other coated particles, a composite powder is known which includes a base powder and spherical barium sulfate particles having a number average particle diameter of 0.5 to 5.0 μm and adhering, in the form of protrusions, to a surface of the base powder; a coating ratio of the spherical barium sulfate particles is 10 to 70% relative to a surface area of the base powder (PTL 7).

Furthermore, as composite-oxide-coated particles, a bluish green pigment is known in which a substrate of a flaky fine powder is covered with a metal composite oxide including oxides of magnesium, calcium, cobalt, and titanium, with a coating weight being 5 to 70 weight percent on the basis of a total weight of the pigment, the powder being selected from powders of mica, talc, kaolin, sericite, synthetic mica, and the like (PTL 8).

Furthermore, other composite-metal-oxide-coated particles are as follows. A flaky alumina pigment is known in which, on a surface of flaky alumina, a colored composite metal oxide that has reacted with the surface is present (PTL 9). A wurtzite-type inorganic pigment is known in which, on a surface of body particles having a wurtzite-type structure, such as those of ZnO, ZnO₁₋ₓ(0<x<1), ZnS, GaN, Bn, or

SiC, a wurtzite-type compound having a composition different from that of the particles is present (PTL 10).

### CITATION LIST

### Patent Literature

[PTL 1] Japanese Unexamined Patent Application Publication No. 2003-192338
[PTL 2] Japanese Unexamined Patent Application Publication. No. 2002-249315
[PTL 3] Japanese Unexamined Patent Application Publication No. 9-59018
[PTL 4] Japanese Unexamined Patent Application Publication No. 2009-35430
[PTL 5] Japanese Unexamined Patent Application Publication No. 2016-222501
[PTL 6] Japanese Unexamined Patent Application Publication No. 2005-306635
[PTL 7] Japanese Unexamined Patent Application Publication No. 2004-300080
[PTL 8] Japanese Unexamined Patent. Application Publication No. 4-28771
[PTL 9] Japanese Unexamined Patent Application Publication No. 7-331110
[PTL 10] Japanese Unexamined Patent Application Publication No. 2003-221524

### SUMMARY OF INVENTION

### Technical Problem

However, none of PTL 1 to 7 discloses coated alumina particles having a coating that includes a composite metal oxide.

PTL 8 states that a non-aluminum substrate is covered with a metal composite oxide including oxides of magnesium, calcium, cobalt, and titanium, with a coating weight being 5 to 70 weight percent on the basis of a total weight of the pigment, and, consequently, the resulting bluish green pigment has high intensity and saturation and has good safety and stability. However, PTL 8 does not disclose coated alumina particles having a coating that includes a composite metal oxide.

PTL 9 states that, on a surface of flaky alumina, a colored composite metal oxide that has reacted with the alumina in the surface is present, and, consequently, the resulting flaky alumina pigment has excellent coatability and high-temperature stability. However, PTL 9 does not disclose coated alumina particles having a coating that includes a composite metal oxide containing more than one metal other than aluminum, PTL 10 states that, on a surface of body particles having a wurtzite-type structure, a wurtzite-type compound having a composition different from that of the particles is present, and, consequently, the resulting wurtzite-type inorganic pigment is non-toxic, has excellent high-temperature stability, and has high saturation. However, PTL 10 does not disclose coated alumina particles having a coating that includes a composite metal oxide.

The present invention has been made in view of the above circumstances, and objects of the present invention are to provide composite particles in which selectivity for coating materials is improved and to provide a method for producing the composite particles.

### Solution to Problem

The present inventors diligently performed studies to achieve the objects described above and consequently found that when molybdenum is present in a surface region of alumina particles that serve as the bodies that form composite particles, the alumina particles can be covered with an inorganic coating that includes a composite metal oxide containing any of various multiple metal species, and, therefore, selectivity for coating materials is remarkably improved. Accordingly, the present inventors completed the present invention. Furthermore, with the combination of the molybdenum present in the alumina particles and other multiple metal species present in the inorganic coating, utilization of the composite particles in various fields, such as the field of catalysts, can be expected. Specifically, the present invention provides the following means for achieving the objects described above.
[1]Composite particles including alumina particles and an inorganic coating disposed on a surface of the alumina particles, the alumina particles containing molybdenum (Mo), the inorganic coating including a composite metal oxide.
[2] The composite particles according to [1], wherein the composite metal oxide includes a metal oxide of two or more metals selected from iron (Fe), titanium. (Ti), zinc (Zn), nickel (Ni), cobalt (Co), manganese (Mn), and aluminum (Al).
[3] The composite particles according to [1], wherein the composite metal oxide includes a first metal oxide and a second metal oxide, the first metal oxide being a metal oxide of a metal selected from iron (Fe), titanium (Ti), zinc (Zn), nickel (Ni), cobalt (Co), and manganese (Mn), the second metal oxide being a metal oxide of a metal selected from iron (Fe), titanium (Ti), zinc (Z,n), nickel (Ni), cobalt (Co), and manganese (Mn), the second metal oxide being different from the first metal oxide.
[4] The composite particles according to [1], wherein the alumina particles further contain silicon (Si) and/or germanium (Ge).
[5] The composite particles according to [4], wherein the alumina particles include mullite in a surface layer of the alumina particles.
[6] The composite particles according to any one of [1] to [5], wherein the composite particles have one of a flaky shape, a spherical shape, and a polyhedral shape.
[7] The composite particles according to any one of [1] to [6], wherein the composite particles have a flaky shape, a thickness of 0.01 μm or greater and 5 μm or less, an average particle diameter of 0.1 μm or greater and 500 μm or less, and an aspect ratio of 2 or greater and 500 or less.
[8] A coating formulation, an ink, or a molded article including the composite particles according to any one of [1] to [7].
[9] A method for producing composite particles, the method including the steps of:
producing alumina particles by sintering a mixture that includes an aluminum compound and a molybdenum compound, the aluminum compound containing elemental aluminum, the molybdenum compound containing elemental molybdenum, or by sintering a mixture that includes an aluminum compound, a molybdenum compound, and a shape control agent for controlling a shape of the alumina particles, the aluminum compound containing elemental aluminum, the molybdenum compound containing elemental molybdenum; and forming an inorganic coating on a surface of the alumina particles, the inorganic coating including a composite metal oxide.
[10] The method for producing composite particles according to [9], wherein the shape control agent includes one or more selected from silicon, a silicon compound, and a germanium compound, the silicon compound containing elemental silicon, the germanium compound containing elemental germanium.
[11] The method for producing composite particles according to [9] or [10], wherein the mixture further includes a potassium compound containing elemental potassium.
[12] The method for producing composite particles according to [9], wherein the composite metal oxide includes a metal oxide of two or more metals selected from iron (Fe), titanium (Ti), zinc (Z,n), nickel (Ni), cobalt (Co), manganese (Mn), and aluminum (Al)
[13] The method for producing composite particles according to [9], wherein the composite metal oxide includes a first metal oxide and a second metal oxide, the first metal oxide being a metal oxide of a metal selected from iron. (Fe), titanium (Ti), zinc (Zn), nickel (Ni), cobalt (Co), and manganese (Mn), the second metal oxide being a metal oxide of a metal selected from iron. (Fe), titanium (Ti), zinc (Zn), nickel (Ni), cobalt (Co), and manganese (Mn), the second metal oxide being different from the first metal oxide.
[14] The method for producing composite particles according to [9], wherein, in the forming of the inorganic coating, a metal inorganic salt containing at least one metal other than aluminum (A1) is contacted with the alumina particles, and then, the metal inorganic salt, which is deposited on the alumina particles, is converted into the composite metal oxide.
[15] The method for producing composite particles according to [9], wherein the forming of the inorganic coating includes a first conversion step and a second conversion step, in the first conversion step, a first metal inorganic salt containing at least one metal other than aluminum (A1) is contacted with the alumina particles, and then, the first metal inorganic salt, which is deposited on the alumina particles, is converted into a metal oxide, and in the second conversion step, a second metal inorganic salt is contacted with the metal oxide and/or the alumina particles, the second metal inorganic salt containing at least one different metal, the different metal being a metal other than aluminum (A1) and different from the metal used in the first conversion step, and then, the metal oxide and/or the second metal inorganic salt are converted into the composite metal oxide.

With the present invention, composite particles are provided in which selectivity for coating materials is improved.

### BRIEF DESCRIPTION OF DRAWINGS

FIG. 1 is an electron microscope image of composite particles obtained in Example 3, the image showing an example of a configuration of composite particles according to an embodiment of the present invention.

FIG. 2 is an enlarged image of the composite particles shown in FIG. 1.

FIG. 3 is an enlarged image of a surface of the composite particles shown in FIG. 1.

FIG. 4 is an electron microscope image of composite particles obtained in Example 6, the image showing an example of a configuration of composite particles according to an embodiment of the present invention.

FIG. 5 is an enlarged image of the composite particles shown in FIG. 4.

FIG. 6 is an enlarged image of a surface of the composite particles shown in FIG. 4.

FIG. 7 is an electron microscope image of composite particles obtained in Example 12, the image showing an example of a configuration of composite particles according to an embodiment of the present invention.

FIG. 8 is an enlarged image of the composite particles shown in FIG. 7.

FIG. 9 is an enlarged image of a surface of the composite particles shown in FIG. 7.

FIG. 10 is an electron microscope image of composite particles obtained in Example 14, the image showing an example of a configuration of composite particles according to an embodiment of the present invention.

FIG. 11 is an enlarged image of the composite particles shown in FIG. 10.

FIG. 12 is an enlarged image of a surface of the composite particles shown in FIG. 10.

FIG. 13 is an electron microscope image of composite particles obtained in Comparative Example 1.

FIG. 14 is an enlarged image of the composite particles shown in FIG. 13.

FIG. 15 is an enlarged image of the composite particles shown in FIG. 13.

### DESCRIPTION OF EMBODIMENTS

Embodiments of the present invention will now be described in detail with reference to the figures.

### First Embodiment

### Composite Particles

Composite particles according to a first embodiment include alumina particles and an inorganic coating disposed on a surface of the alumina particles. The alumina particles contain molybdenum (Mo). The inorganic coating includes a composite metal oxide. The alumina particles of the embodiment have a flaky shape, and the composite particles also have a flaky shape. Hereinafter, in the embodiment, alumina particles having a flaky shape will also be referred to as “flaky alumina particles”, “flaky alumina”, or, simply, “alumina particles”.

### Flaky Alumina Particles

As used in the present invention, the term “flaky” refers to having an aspect ratio of 2 or greater. The aspect ratio is a ratio obtained by dividing an average particle diameter of the alumina particles by a thickness of the alumina particles. Note that in this specification, the “thickness of the alumina particles” is the arithmetic mean of measured thicknesses of at least 50 flaky alumina particles, which are randomly selected from an image obtained with a scanning electron microscope (SEM). Furthermore, the “average particle diameter of the alumina particles” is a value calculated as a volume-based median diameter D₅₀ from a volume-based cumulative particle size distribution, which is measured by a laser diffraction particle diameter analyzer.

In the alumina particles, the attributes, namely, the thickness, the particle diameter, and the aspect ratio, which are described below, may be in any of various combinations provided that the alumina particles have a flaky shape. Furthermore, the upper limits and lower limits of the numerical ranges of the attributes, which are mentioned as examples, can be freely combined with each other.

The thickness of the flaky alumina particles is preferably 0.01 μm or greater and 5 μm or less, more preferably 0.03 μm or greater and 5 μm or less, even more preferably 0.1 μm or greater and 5 μm or less, still more preferably 0.3 μm or greater and 3 μm or less, and still further more preferably 0.5 μm or greater and 1 μm or less.

In a case where flaky alumina particles having a larger particle diameter are to be used, the thickness is preferably greater than or equal to 3 μm and more preferably 5 μm or greater and 60 μm or less.

When the thickness is any of the above-mentioned thicknesses, the alumina particles have a high aspect ratio and excellent mechanical strength, and, therefore, such a thickness is preferable.

The average particle diameter (D₅₀) of the flaky alumina particles is preferably 0.1 μm or greater and 500 μm or less, more preferably 0.5 μm or greater and 100 μm or less, and even more preferably 1 μm or greater and 50 μm or less. In a case where flaky alumina particles having a larger particle diameter are to be used, the average particle diameter (D₅₀) is preferably greater than or equal to 10 μm, more preferably greater than or equal to 20 μm, even more preferably greater than or equal to 22 μm, still more preferably greater than or equal to 25 μm, and particularly preferably greater than or equal to 31 μm. The upper limit of the average particle diameter is not particularly limited. For example, the average particle diameter (D₅₀) of the flaky alumina particles of the embodiment is 10 μm or greater and 500 μm or less, more preferably 20 μm or greater and 300 μm or less, even more preferably 22 μm or greater and 100 μm or less, still more preferably 25 μm or greater and 100 μm or less, and particularly preferably 31 μm or greater and 50 μm or less.

When the average particle diameter (D₅₀) is greater than or equal to the lower limit, the alumina particles have a light reflective surface having a large area, and, therefore, the alumina particles have, in particular, excellent luminescent properties. Furthermore, when the average particle diameter (D₅₀) is less than or equal to the upper limit, the alumina particles are suitable for use as a filler.

The aspect ratio of the flaky alumina particles, which is the ratio of the average particle diameter to the thickness, is preferably 2 or greater and 500 or less, more preferably 5 or greater and 500 or less, even more preferably 15 or greater and 500 or less, still more preferably 10 or greater and 300 or less, yet more preferably 17 or greater and 300 or less, and still further more preferably 33 or greater and 100 or less. When the aspect ratio is greater than or equal to 2, the flaky alumina particles can have two-dimensional mixing characteristics, and, therefore, such an aspect ratio is preferable. When the aspect ratio is less than or equal to 500, the flaky alumina particles have excellent mechanical strength, and, therefore, such an aspect ratio is preferable. When the aspect ratio is greater than or equal to 15, the flaky alumina particles can form a high-luminescent pigment, and, therefore, such an aspect ratio is preferable, in a case where flaky alumina particles having a larger particle diameter are to be used, the aspect ratio, which is the ratio of the average particle diameter to the thickness, is preferably 2 or greater and 50 or less and more preferably 3 or greater and 30 or less.

The flaky alumina particles may have a circular flake shape or an elliptical flake shape, but, in terms of handleability and ease of production, it is preferable that a shape of the particles be, for example, a polygonal flake shape.

The flaky alumina particles may be obtained by using any production method. From the standpoint of achieving a higher aspect ratio, higher dispersibility, and higher productivity, it is preferable that the flaky alumina particles be obtained by firing an aluminum compound in the presence of a molybdenum compound (and a potassium compound, preferably) and a shape control agent. A suitable shape control agent to be used is at least one selected from the group consisting of silicon, silicon compounds, and germanium compounds). More preferably, the shape control agent is silicon or a silicon compound that contains elemental silicon because in this case, the shape control agent can be a source of Si of mullite, which will be described later.

In the production method, the molybdenum compound is used as a fluxing agent. In this specification, hereinafter, the production method that uses a molybdenum compound as a fluxing agent may be referred to simply as a “flux method”. The flux method will be described in detail later. Note that in the firing, the molybdenum compound and the aluminum compound react with each other at a high temperature to form aluminum molybdate, and thereafter, presumably, when the aluminum molybdate decomposes into alumina and molybdenum oxide at a higher temperature, a molybdenum compound is incorporated into the flaky alumina particles. Molybdenum oxide that undergoes sublimation can be recovered and recycled.

Note that in a case where the flaky alumina particles include mullite in a surface layer thereof, the following process presumably occurs in the process mentioned above: silicon or a compound that contains silicon atoms, which is included as a shape control agent, reacts with the aluminum compound via the molybdenum, and as a result, mullite is formed in the surface layer of the flaky alumina particles. More specifically, the mechanism by which the mullite is formed is presumably as follows: in a flake surface of the alumina, molybdenum and Si atoms react with each other to form Mo—O—Si, and molybdenum and Al atoms react with each other to form Mo—O—Al, and, in high-temperature firing, Mo is removed, and mullite, which has a Si—O—Al bond, is formed.

It is preferable that molybdenum oxide that is not incorporated into the flaky alumina particles be recovered by sublimation and recycled. In this case, an amount of molybdenum oxide that adheres to the surface of the flaky alumina can be reduced, and, therefore, in a case where the flaky alumina is dispersed in a dispersion medium, example of which include an organic binder such as a resin and an inorganic binder such as glass, unintentional incorporation of the molybdenum oxide into the binder can be prevented, and, consequently, the inherent properties of flaky alumina can be maximally provided.

Note that in this specification, regarding the production method to be described later, a material that has a property of being sublimable is referred to as a fluxing agent, and a material that is not sublimable is referred to as a shape control agent.

The use of molybdenum and a shape control agent in the production of the flaky alumina particles enables the alumina particles to have a euhedral shape with a high degree of α crystallization and, therefore, to have excellent dispersibility and mechanical strength and high thermal conductivity.

In a case where the flaky alumina particles include mullite in a surface layer thereof, an amount of the mullite formed in the surface layer of the flaky alumina particles can be controlled by the usage ratios of the molybdenum compound and the shape control agent. In particular, the amount of the mullite can be controlled by the usage ratio of the silicon or the silicon compound that contains elemental silicon, which is used as a shape control agent. Preferred values of the amount of the mullite formed in the surface layer of the flaky alumina particles and preferred usage ratios of the raw materials will be described in detail later.

From the standpoint of improving luminescent properties, it is preferable that the flaky alumina particles be as follows: the flaky alumina particles have an aspect ratio of 5 to 500, and, in solid ²⁷Al NMR analysis conducted on the flaky alumina particles at a static magnetic field strength of 14.1 T, a longitudinal relaxation time T₁ associated with a peak of six-coordinated aluminum at 10 to 30 ppm is greater than or equal to 5 seconds.

The longitudinal relaxation time T₁ of greater than or equal to 5 seconds indicates that the flaky alumina particles have high crystallinity. There is reported knowledge that a long solid-state longitudinal relaxation time indicates good crystal symmetry and high crystallinity (reported in Susumu Kitagawa et al., Japan Society of Coordination Chemistry selection., “Takakushu no yoeki oyobi kotai NMR (Multinuclear Solution and Solid NMR)”, published by Sankyo Shuppan Co., Ltd., pp. 80-82).

The longitudinal relaxation time T₁ of the flaky alumina particles is preferably greater than or equal to 5 seconds, more preferably greater than or equal to 6 seconds, and even more preferably greater than or equal to 7 seconds. For the flaky alumina particles of the embodiment, the upper limit of the longitudinal relaxation time T₁ is not particularly limited. For example, the upper limit may be less than or equal to 22 seconds, less than or equal to 15 seconds, or less than or equal to 12 seconds.

Examples of numerical ranges for the longitudinal relaxation times TI mentioned above as examples may be 5 seconds or greater and 22 seconds or less, 6 seconds or greater and 15 seconds or less, or 7 seconds or greater and 12 seconds or less.

In solid ²⁷Al NMR analysis conducted on the flaky alumina particles at a static magnetic field strength of 14.1 T, it is preferable that a peak of four-coordinated aluminum at 60 to 90 ppm not be detected. In this case, presumably, the flaky alumina particles are unlikely to experience breakage or falling originating at a symmetry distortion of a crystal, which can be caused when crystals having different coordination numbers are present; thus, the flaky alumina particles tend to have a higher shape stability.

In the related art, the degree of crystallinity of inorganic materials is typically evaluated based on the results of XRD analysis or the like. However, the present inventors conducted studies and found that more accurate analysis results than those obtained by XRD analysis, as in the related art, can be obtained by using the longitudinal relaxation time T₁ as an index for the evaluation of the crystallinity of alumina particles. The flaky alumina particles of the embodiment have a long longitudinal relaxation time T₁ of greater than or equal to 5 seconds, and, therefore, the alumina particles can be presumed to have high crystallinity. That is, presumably, in the flaky alumina particles of the embodiment, probably because of the high crystallinity, diffuse reflection from the crystal faces is inhibited, and, therefore, light reflection is improved, and as a result, the flaky alumina particles have excellent luminescent properties.

In addition, the present inventors found that there is a very good correlation between the value of the longitudinal relaxation time T₁ and a shape retention ratio and a resin composition processing stability of flaky alumina particles. In particular, in cases where flaky alumina particles have an average particle diameter of 10 μm or less and an aspect ratio of 30 or less (e.g., Examples 1 and 2), a correlation between the value of the longitudinal relaxation time T₁ and the shape retention ratio and the resin composition processing stability of the flaky alumina particles is significantly exhibited. Flaky alumina particles having a longitudinal relaxation time T₁ of greater than or equal to 5 seconds, such as those described above, also have an advantage in that in a case where a resin composition is produced by mixing the flaky alumina particles with a resin, the resin composition has good processing stability and, therefore, can be easily processed into a desired shape. Flaky alumina particles such as those described above, which have a high long longitudinal relaxation time T₁ value, have enhanced crystallinity. Thus, presumably, since the particles have high strength because of the high crystallinity of the alumina, when a resin and the flaky alumina particles are mixed together in the process of producing a resin composition, the flakes do not easily break, and further, since the particles have few irregularities in a surface thereof probably because of the high crystallinity of the alumina, the particles have excellent adhesion to the resin. Presumably, because of these factors, flaky alumina particles such as those described above have a good resin composition processing stability. Flaky alumina particles such as those described above exhibit the inherent properties of flaky alumina particles favorably even in instances in which, for example, the flaky alumina particles are mixed into a resin composition.

In the related art, regarding flaky alumina particles, compared with spherical alumina particles, it has been difficult to obtain alumina particles having high crystallinity. Presumably, this is because in the case of flaky alumina particles, as opposed to spherical alumina particles, it is necessary, in the process of production, to cause unevenness in the directions in which the crystals grow.

On the contrary, flaky alumina particles that satisfy the value of the longitudinal relaxation time T₁ such as those described above have high crystallinity despite their flaky shape. Accordingly, the flaky alumina particles are very useful in that while having the advantages of flaky alumina particles, such as a property of exhibiting high thermal conductivity, the flaky alumina particles further have an enhanced shape retention ratio and enhanced resin composition processing stability.

Furthermore, the flaky alumina particles of the embodiment have a ratio I (006)/T (113), which is the ratio of a peak intensity 1 (006) at 20=41.6±0.3 degrees, which corresponds to the (006) face, to a peak intensity I (113) at 20-43.3±0.3 degrees, which corresponds to the (113) face, as determined by diffraction peaks obtained in an X-ray diffraction measurement using Cu-Ku radiation (hereinafter, the ratio I (006)/I (113) will be abbreviated as a “(006/113) ratio”). The (006/113) ratio is preferably 0.2 or greater and 30 or less, more preferably 1 or greater and 20 or less, even more preferably 3 or greater and 10 or less, and particularly preferably 7.5 or greater and 10 or less. In these cases, the flaky alumina particles have an average particle diameter (D₅₀ of greater than or equal to 10 μm and a thickness of greater than or equal to 0.1 μm, for example.

It is understood that high values of the (006/113) ratio indicate that a proportion of the (006) face is high relative to a proportion of the (113) face, and, therefore, the alumina particles are flaky alumina particles in which faces corresponding to the crystal in the orientation of the (006) face have been significantly developed. The flaky alumina particles exhibit high luminescent properties even when the mass per particle thereof is small, because, in the flaky alumina particles, an upper face or a lower face developed on the flaky surface of the flaky alumina has a large area, which results in increased visibility for reflected light reflected from the upper face or the lower face, and also, formation of faces corresponding to the crystal in the orientation of the (113) face is inhibited.

A pH of an isoelectric point of the flaky alumina particles is, for example, within a range of 2 to 6. The pH of the isoelectric point is preferably within a range of 2.5 to 5 and more preferably within a range of 3 to 4. When the flaky alumina particles have a pH of the isoelectric point within any of the above-mentioned ranges, the flaky alumina particles exhibit high electrostatic repulsion and, therefore, can exhibit enhanced dispersion stability on their own in an instance where the flaky alumina particles are added to a dispersion medium, such as those described above, and, therefore, modification for achieving a further improvement in performance by surface treatment that uses a coupling agent or the like is facilitated.

The value of the pH of the isoelectric point can be obtained as follows. For the measurement of the zeta potential, a zeta potential analyzer (Zetasizer Nano ZSP, from Malvern) is used. 20 mg of a sample and 10 mL of a 10 mM aqueous KCl solution are stirred in an Awatori Rentaro (ARE-310, from Thinky Corporation) for 3 minutes in a stirring/defoaming mode, and the resultant is allowed to stand for 5 minutes. The resulting supernatant is used as a measurement sample. By adding 0.1 N HCl to the sample by using an automatic titrator, the zeta potential is measured in a range up to a pH of 2 (an applied voltage of 100 V, a Monomodal mode). Accordingly, the pH of the isoelectric point, at which the potential is zero, is evaluated.

The flaky alumina particles have a density of 3.70 g/cm. 3 or greater and 4.10 g/cm 3 or less, for example. The density is preferably 3.72 g/cm 3 or greater and 4.10 g/cm 3 or less, and more preferably, the density is 3.80 g/cm 3 or greater and 4.10 g/cm 3 or less.

The density can be measured as follows. The flaky alumina particles are subjected to a pre-treatment under the conditions of 300° C. and 3 hours. Subsequently, a measurement is performed by using a dry automatic densimeter AccuPyc II 1330, manufactured by Micromeritics, under conditions including a measurement temperature of 25° C. and the use of helium as a carrier gas.

### Alumina

The alumina present in the flaky alumina particles is aluminum oxide and, for example, may be any of various types of transition alumina that have a crystalline form such as γ, δ, θ, or κ, and the transition alumina may include an alumina hydrate. However, basically, it is preferable that the alumina be alumina having an α-crystalline form (a type), in terms of higher mechanical strength or higher thermal conductivity. The α-crystalline form is a dense crystal structure of alumina and is, therefore, advantageous in improving the mechanical strength or thermal conductivity of the flaky alumina. It is preferable that the degree of α crystallization be as close as possible to 100% because in such a case, the inherent properties of the α-crystalline form can be easily exhibited. The degree of α crystallization of the flaky alumina particles is, for example, greater than or equal to 90%. The degree of α crystallization is preferably greater than or equal to 95% and more preferably greater than or equal to 99%.

### Silicon and Germanium

The flaky alumina particles of the embodiment may contain silicon (Si) and/or germanium (Ge).

The silicon and/or germanium may be ones derived from silicon, a silicon compound, and/or a germanium compound that can be used as a shape control agent. By utilizing any of these, flaky alumina particles having excellent luminescent properties can be produced in a product ion method, which will be described later.

### Silicon

The flaky alumina particles of the embodiment may contain silicon. The flaky alumina particles of the embodiment may contain silicon in a surface layer thereof.

As used herein, the term “surface layer” refers to a region within 1.0 nm of the surface of the flaky alumina particles of the embodiment. The distance corresponds to the probing depth of the XPS used for a measurement in the Examples.

In the Flaky alumina particles, silicon may be localized in the surface layer. As used herein, the expression “localized in the surface layer” refers to a state in which the mass of silicon per unit volume in the surface layer is greater than the mass of silicon per unit volume in the remaining portion, other than the surface layer. The determination that silicon is localized in the surface layer can be made by comparing the result of analysis of the surface, which is performed by XPS, and the result of analysis of the entirety, which is performed by XRF.

The silicon that may be included in the flaky alumina particles may be elemental silicon or silicon present in a silicon compound. The flaky alumina particles may contain, as silicon or a silicon compound, at least one selected from the group consisting of mullite, Si, SiO₂, SiO, and aluminum silicate formed by a reaction with the alumina; any of these substances may be included in the surface layer. The mullite will be described later.

In a case where silicon or a silicon compound that contains elemental silicon is used as a shape control agent, Si can be detected from the flaky alumina particles by XRF analysis. In the flaky alumina particles, a molar ratio [Si]/[Al], which is the ratio of moles of Si to moles of Al determined by XRF analysis, is, for example, less than or equal to 0.04. The molar ratio [Si]/[Al] is preferably less than or equal to 0.035 and more preferably less than or equal to 0.02.

Furthermore, the value of the molar ratio [Si]/[Al] is not particularly limited and is, for example, greater than or equal to 0.003. The value is preferably greater than or equal to 0.004 and more preferably greater than or equal to 0.005.

In the flaky alumina particles, the molar ratio [Si]/[Al], which is the ratio of moles of Si to moles of Al determined by XRF analysis, is, for example, 0.003 or greater and 0.04 or less. The molar ratio [Si]/[Al] is preferably 0.004 or greater and 0.035 or less and more preferably 0.005 or greater and 0.02 or less.

When the value of the molar ratio [Si]/[Al] determined by XRF analysis of the flaky alumina particles is within any of the above-mentioned ranges, the value of the (006/113) ratio mentioned above is satisfied, so that more preferred luminescent properties are achieved, and the flaky shape is favorably formed. Furthermore, adhering objects are unlikely to adhere to a surface of the flaky alumina particles, and, therefore, excellent quality is achieved. The adhering objects are presumed to be SiO₂ particles, which are believed to be derived from excess Si that results from an instance in which the formation of mullite in the surface layer of the flaky alumina particles has reached a maximum level.

In a case where flaky alumina particles having a larger particle diameter are to be used, the molar ratio [Si]/[Al] of the flaky alumina particles, which is the ratio of moles of Si to moles of Al determined by XRF analysis, is preferably 0.0003 or greater and 0.01 or less, more preferably 0.0005 or greater and 0.0025 or less, and even more preferably 0.0006 or greater and 0.001 or less.

The flaky alumina particles may contain silicon corresponding to the silicon or the silicon compound that contains elemental silicon used in a method for producing the flaky alumina particles. A content of the silicon, calculated as silicon dioxide, is preferably less than or equal to 10 mass % relative to a total mass of the flaky alumina particles taken as 100 mass %; the content is more preferably 0.001 to 5 mass %, even more preferably 0.01 to 4 mass %, still more preferably 0.3 to 2.5 mass %, and particularly preferably 0.6 to 2.5 mass %.

When the content of the silicon is within any of the above-mentioned ranges, the value of the (006/113) ratio mentioned above is satisfied, so that more preferred luminescent properties are achieved, and the flaky shape is favorably formed. Furthermore, adhering objects presumed to be SiO₂ particles are unlikely to adhere to the surface of the Flaky alumina particles, and, therefore, excellent quality is achieved.

In a case where flaky alumina particles having a larger particle diameter are to be used, the content of the silicon calculated as silicon dioxide is preferably less than or equal to 10 mass % relative to the total mass of the flaky alumina particles taken as 100 mass %; the content is more preferably 0.001 to 3 mass %, even more preferably 0.01 to 1 mass %, and particularly preferably 0.03 to 0.3 mass %.

### Mullite

The flaky alumina particles of the embodiment may include mullite. It is inferred that with the presence of mullite in the surface layer of the flaky alumina particles, selectivity for inorganic materials that can form the inorganic coating is improved, and, therefore, the inorganic coating can be efficiently formed on the flaky alumina particles.

The presence of mullite in the surface layer of the flaky alumina particles results in a prominent reduction in the wearing out of devices. The mullite, which may be present in the surface layer of the flaky alumina particles, is a composite oxide of Al and Si and represented by AlₓSi_{y}O_{z}, where the values of x, y, and z are not particularly limited. A more preferred range is Al₂Si₁O₅ to Al₆Si₂O₁₃. Note that the XRD peak intensities identified in the Examples, which will be described later, are those of Al_{2.85}Si₁O_{6.3}, Al₃Si₁O_{6.5}, Al_{3.67}Si₁O_{7.5}, Al₄Si₁O₈, and Al₆Si₂O₁₃. The flaky alumina particles may include, in the surface laver, at least one compound selected from the group consisting of Al_{2.85}Si₁O_{6.3}, Al₃Si₁O_{6.5}, Al_{3.67}Si₁O_{7.5}, Al₄Si₁O₈, and Al₆Si₂O₁₃. As used herein, the term “surface layer” refers to a region within 10 nm of the surface of the flaky alumina particles. The distance corresponds to the probing depth of the XPS used for a measurement in the Examples. In the flaky alumina particles, it is preferable that mullite be localized in the surface layer. As used herein, the expression “localized in the surface laver” refers to a state in which the mass of mullite per unit volume in the surface layer is greater than the mass of mullite per unit volume in the remaining portion, other than the surface layer.

Furthermore, the mullite in the surface layer may be in the form of a mullite layer or in a state in which the mullite and the alumina coexist. Regarding the interface between the mullite and the alumina in the surface layer, the mullite and the alumina may be in physical contact with each other, or the mullite and the alumina may form a chemical bond such as Si—O—Al.

### Germanium

The flaky alumina particles of the embodiment may contain germanium. The flaky alumina particles may contain germanium in the surface layer thereof.

The flaky alumina particles may contain germanium or a germanium compound, which may vary depending on the raw material used. For example, the germanium or the germanium compound is at least one selected from the group consisting of Ge, compounds such as GeO₂, GeO, GeCl₂, GeBr₄, GeI₄, GeS₂, AlGe, GeTe, GeTe₃, GeAs₂, GeSe, GeS₃As, SiGe, Li₂Ge, FeGe, SrGe, and GaGe, oxides of any of these, and the like; any of these substances may be present in the surface layer.

Note that the germanium or the germanium compound that may be included in the flaky alumina particles and a raw material germanium compound used as a shape control agent, which is a raw material, may be the same type of germanium compound. For example, GeO₂ may be detected from flaky alumina particles produced by addition of GeO₂ as a raw material.

The presence of germanium or a germanium compound in the surface layer of the flaky alumina particles results in a prominent reduction in the wearing out of devices. As used herein, the term “surface layer” refers to a region within 10 nm of the surface of the flaky alumina particles.

In the flaky alumina particles, it is preferable that germanium or a germanium compound be localized in the surface layer. As used herein, the expression “localized in the surface layer” refers to a state in which the mass of germanium or a germanium compound per unit volume in the surface layer is greater than the mass of germanium or a germanium compound per unit volume in the remaining portion, other than the surface layer. The determination that germanium or a germanium compound is localized in the surface layer can be made by comparing the result of analysis of the surface, which is performed by XPS, and the result of analysis of the entirety, which is performed by XRF.

The flaky alumina particles contain germanium corresponding to the raw material germanium compound used in a method for producing the flaky alumina particles. A content of the germanium, calculated as germanium dioxide, is preferably less than or equal to 10 mass % relative to the total mass of the flaky alumina particles taken as 100 mass %; the content is more preferably 0.001 to 5 mass %, even more preferably 0.01 to 4 mass %, and particularly preferably 0.1 to 3.0 mass %. When the content of the germanium is within any of the above-mentioned ranges, the amount of the germanium or the germanium compound is appropriate, and, accordingly, the value of the (006/11) ratio mentioned above is satisfied, so that more preferred luminescent properties are achieved. Accordingly, such a content is preferable. The content of the germanium can be determined by XRF analysis.

The XRF analysis is to be conducted under the conditions that are the same as the measurement conditions listed in the Examples section, which will be described later, or under compatible conditions under which the same measurement results can be obtained.

Furthermore, the germanium or the germanium compound in the surface layer may be in the form of a layer or in a state in which the germanium or the germanium compound and the alumina coexist. Regarding the interface between the germanium or the germanium compound and the alumina in the surface layer, the germanium or the germanium compound and the alumina may be in physical contact with each other, or the germanium or the germanium compound and the alumina may form a chemical bond such as Ge—O—Al.

### Molybdenum

The flaky alumina particles of the embodiment contain molybdenum. It is preferable that the flaky alumina particles contain molybdenum in the surface layer. It is inferred that in this case, selectivity for inorganic materials that can form the inorganic coating is improved, and, therefore, the inorganic coating can be efficiently formed on the flaky alumina particles.

The molybdenum may be molybdenum derived from the molybdenum compound used as a fluxing agent in the method for producing alumina particles to be described later.

Molybdenum has a catalytic function and an optical function. Furthermore, with the use of molybdenum, flaky alumina particles having high crystallinity despite their flaky shape and having excellent luminescent properties can be produced in the production method to be described later.

When an amount of usage of molybdenum is increased, the particle size and the value of the (006/113) ratio mentioned above tend to be satisfied, and, consequently, the luminescent properties of the resulting alumina particles tend to be further enhanced. Furthermore, with the use of molybdenum, the formation of mullite is promoted, and, therefore, flaky alumina particles having a high aspect ratio and excellent dispersibility can be produced. Furthermore, the characteristics of the molybdenum included in the flaky alumina particles can be utilized to use the flaky alumina particles in applications such as catalysts for oxidation reactions and optical materials.

Examples of the molybdenum include, but are not limited to, molybdenum metal, molybdenum oxide, partially reduced molybdenum compounds, and molybdate salts. One of the polymorphs of molybdenum compounds or a combination of two or more thereof may be included in the flaky alumina particles. For example, any one or more of α—MoO₃, β-moO₃, MoO₂, MoO, and a molybdenum cluster structure may be included in the flaky alumina particles.

The form in which the molybdenum is present is not particularly limited, and any of the following forms is possible: a form in which molybdenum adheres to the surface of the flaky alumina particles; a form in which molybdenum partially replaces aluminum in the crystal structure of the alumina; and a combination of these forms.

A content of the molybdenum, calculated as molybdenum trioxide, as determined by XRF analysis, is preferably less than or equal to 10 mass % relative to the total mass of the flaky alumina particles taken as 100 mass %; the content is more preferably 0.001 to 5 mass %, even more preferably 0.01 to 5 mass %, and particularly preferably 0.1 to 1.5 mass %, which can be achieved by adjusting a firing temperature, a firing time, and/or a rate of sublimation of the molybdenum compound. When the content of the molybdenum is less than or equal to 10 mass %, the quality of the α single crystal of the alumina is improved. Accordingly, such a content is preferable.

In a case where flaky alumina particles having a larger particle diameter are to be used, the content of the molybdenum, calculated as molybdenum trioxide, is preferably less than or equal to 10 mass % relative to the total mass of the flaky alumina particles of the embodiment taken as 100 mass %; the content is more preferably 0.1 to 5 mass %, and even more preferably 0.3 to 1 mass %, which can be achieved by adjusting the firing temperature, the firing time, and/or the rate of sublimation of the molybdenum compound.

The content of the molybdenum can be determined by XRF analysis. The XRF analysis is to be conducted under the conditions that are the same as the measurement conditions listed in the Examples section, which will be described later, or under compatible conditions under which the same measurement results can be obtained.

Furthermore, analysis of the Mo content in the surface of the alumina particles can be carried out by using an X-ray photoelectron spectroscopy (XPS) instrument as described above.

### Potassium

The flaky alumina particles may further contain potassium.

The potassium may be potassium derived from the potassium that may be used as a fluxing agent in the method for producing alumina particles to be described later. With the use of potassium, the particle diameter of the alumina particles can be suitably improved in the method for producing alumina particles to be described later.

Examples of the potassium include, but are not limited to, potassium metal, potassium oxide, and partially reduced potassium compounds.

The form in which the potassium is present is not particularly limited, and any of the following forms is possible: a form in which potassium adheres to the surface of the flaky alumina of the flaky alumina particles; a form in which potassium partially replaces aluminum in the crystal structure of the alumina; and a combination of these forms.

A content of the potassium, calculated as potassium oxide (K₂O), as determined by XRF analysis, is preferably greater than or equal to 0.01 mass % relative to the total mass of the alumina particles taken as 100 mass %; the content is more preferably 0.01 to 1.0 mass %, even more preferably 0.03 to 0.5 mass %, and particularly preferably 0.05 to 0.3 mass %. When the content of the potassium is within any of the above-mentioned ranges, the alumina particles have a polyhedral shape and have an average particle diameter and the like having suitable values. Accordingly, such a content of the potassium is preferable.

### Other Elements

Other elements are elements that are intentionally added to the alumina particles to an extent in which the effects of the present invention are not impaired. The purpose of the addition is to impart mechanical strength or electrical and/or magnetic properties.

Examples of the other elements include, but are not limited to, zinc, manganese, calcium, strontium, and yttrium. One of these other elements may be used alone, or two or more thereof may be used in combination.

A content of the other elements in the alumina particles is preferably less than or equal to 5 mass % and more preferably less than or equal to 2 mass %, relative to a mass of the alumina particles.

### Incidental Impurities

The alumina particles may include incidental impurities.

The incidental impurities are those derived from a metal compound used in the production, those present in a raw material, and/or those unintentionally incorporated into the alumina particles in a production process. The incidental impurities are actually unnecessary; however, since they are present in trace amounts, they do not affect the characteristics of the alumina particles.

Examples of the incidental impurities include, but are not limited to, magnesium, calcium, strontium, barium, scandium, yttrium, lanthanum, cerium, and sodium. One of these incidental impurities may be present alone, or two or more thereof may be present.

A content of the incidental impurities in the alumina particles is preferably less than or equal to 10000 ppm, more preferably less than or equal to 1000 ppm, and even more preferably 10 to 500 ppm, relative to the mass of the alumina particles.

### Inorganic Coating

The inorganic coating covers at least a portion of the surface of the alumina particles. Preferably, the inorganic coating is formed of an inorganic coating layer that covers at least a portion of the surface of the alumina particles. In other words, at least a portion of the surface of the composite particles is covered with the inorganic coating, and preferably, at least a portion of the surface of the composite particles is covered with the inorganic coating layer.

As described above, the inorganic coating is disposed on the surface of the alumina particles. The expression. “on the surface of the alumina particles” means “on an outer side of the surface of the alumina particles”.

Accordingly, the inorganic coating formed on the outer side of the surface of the alumina particles is to be explicitly distinguished from the surface layer, which is formed inside the surface of the alumina particles and in which mullite and/or germanium may be present.

The inorganic chemical species that forms the inorganic coating may be large relative to the alumina particles. However, it is preferable that the inorganic chemical species be small relative to the alumina particles because in this case, an inorganic coating having a desired coating weight (or coating thickness) can be easily provided in accordance with the purpose. For example, micrometer-scale alumina particles and a 150-nm or less inorganic chemical species may be used in combination. Providing the inorganic coating including an inorganic chemical species smaller than the alumina particles on the outer side of the surface of the alumina particles can be carried out as follows. A small amount of an inorganic chemical species may be used to provide an inorganic coating on a portion of the surface of the alumina in a manner such that the substrate alumina particles can be clearly seen from the outside. Alternatively, a large amount of an inorganic chemical species may be used to provide an inorganic coating in the form of layers of the inorganic species on the surface of the alumina particles, in a manner such that the substrate alumina particles cannot be seen from the outside. A shape of the inorganic chemical species that forms the inorganic coating is not limited. For example, it is preferable that the shape be spherical or polyhedral, because with such a shape, a dense coating can be formed with a minimum amount of usage of the inorganic chemical species, so that the substrate can be easily concealed.

The composite particles of the present invention are particles formed of molybdenum-containing alumina particles and an inorganic coating, which is formed of one or more inorganic chemical species. The composite particles have excellent properties that cannot be exhibited by a simple mixture of alumina particles and an inorganic chemical species. Regarding the composite particles of the present invention, in a case where micrometer-scale molybdenum-containing alumina particles and a non-aggregated 150-nm or less inorganic chemical species are used in combination, the interaction between the two is enhanced, for example, by intermolecular force and, in some cases, a local chemical reaction, and as a result, particularly noticeably excellent properties are exhibited. For example, higher coating characteristics can be obtained, a more uniform inorganic coating can be easily obtained, and the resulting inorganic coating does not easily delaminate from the alumina particles. In this regard, contribution of the molybdenum present in the alumina particles can also be expected. For example, discrete, nanometer-scale particles of an inorganic chemical species can be obtained, for instance, by mechanically pulverizing a micrometer-scale inorganic chemical species; however, in this case, reaggregation or the like immediately occurs, and, therefore, handling for use is not easy. In a case where alumina particles that do not contain molybdenum or an aggregated inorganic chemical species is used, the two merely form a simple mixture, and the mixture does not exhibit properties such as those of the composite particles of the present invention. With the method for producing the composite particles of the present invention to be described later, composite particles that have high coating efficiency can be produced easily.

The inorganic coating of the embodiment includes a composite metal oxide, or preferably, is formed of a composite metal oxide. In this specification, the term “composite metal oxide” refers to a metal oxide that contains two or more metals. The composite metal oxide can be generally classified into the following (i) to (iii): (i) a mixture of a metal oxide (a first compound) that contains two or more metals and a metal oxide (a second compound) of one metal; (ii) a metal oxide (a first compound) that contains two or more metals, and (iii) a mixture of a metal oxide (a first compound) that contains two or more metals and a metal oxide (a second compound) that contains two or more metals.

Examples of the mixture (i) include, but are not limited to, a mixture of a metal oxide of two or more metals selected from iron (Fe), titanium (Ti), zinc (Zn), nickel (Ni), cobalt (Co), manganese (Mn), and aluminum (Al) and a metal oxide of a metal selected from iron (Fe), titanium (Ti), zinc (Zn), nickel (Ni), cobalt (Co) and manganese (Mn). Specific examples of the mixture include a mixture of aluminum-cobalt oxide and iron oxide, a mixture of aluminum-cobalt oxide and titanium oxide, a mixture of cobalt-iron oxide and iron oxide, a mixture of zinc-iron oxide and zinc oxide, a mixture of zinc-titanium oxide and zinc oxide, a mixture of nickel-titanium oxide and nickel oxide, and a mixture of manganese-iron oxide and iron oxide.

In the mixture (i), a plurality of metal oxides (first compounds) that contain two or more metals may be included, and additionally or alternatively, a plurality of metal oxides (second compounds) of a metal selected from iron (Fe), titanium (Ti), zinc (Zn), nickel (Ni), cobalt (Co) and manganese (Mn) may be included.

Examples of the compound (ii) include, but are not limited to, a metal oxide of two or more metals selected from iron (Fe), titanium (Ti), zinc (Zn), nickel (Ni), cobalt (Co), manganese (Mn), and aluminum (Al). Specific examples of the compound include nickel-iron oxide, nickel-titanium oxide, and manganese-iron oxide.

Examples of the mixture (iii) include, but are not limited to, a mixture of a first metal oxide and a second metal oxide. The first metal oxide is a metal oxide of two or more metals selected from iron (Fe), titanium (Ti), zinc (Zn), nickel (Ni), cobalt (Co), manganese (Mn), and aluminum (Al). The second metal oxide is a metal oxide of two or more metals selected from iron (Fe), titanium (Ti), zinc (Zn), nickel (Ni), cobalt (Co), manganese (Mn), and aluminum (Al). The second metal oxide is different from the first metal oxide. Specific examples of the mixture include a mixture of cobalt-titanium oxide and aluminum-cobalt oxide. In the mixture (iii), a plurality of (three or more) metal oxides of two or more metals selected from iron (Fe), titanium (Ti), zinc (Zn), nickel (Ni), cobalt (Co), manganese (Mn), and aluminum (Al) may be included.

A shape of the composite oxide that forms the inorganic coating is not particularly limited. For example, the shape is a particulate shape, such as spherical, acicular, polyhedral, disc-shaped, hollow, or porous. An average particle diameter of the particles of the particulate composite oxide is, for example, preferably 1 nm or greater and 500 nm or less and more preferably 5 nm or greater and 200 nm or less. The particles of the composite oxide may be crystalline or amorphous.

In a case where the inorganic coating is an inorganic coating layer, a thickness of the inorganic coating layer formed on the surface of the alumina particles is preferably 20 nm or greater and 400 nm or less, more preferably 30 nm or greater and 300 nm or less, and particularly preferably 30 nm or greater and 200 nm or less.

The inorganic coating may be formed of one layer or two or more layers. In the case where the inorganic coating is formed of two or more layers, the two or more layers may be formed of different respective materials.

For example, in a case where the inorganic coating is formed of a first layer disposed on the surface of the alumina particles and a second layer disposed on the first layer, a thickness of the first layer is preferably 10 nm or greater and 200 nm or less, more preferably 15 nm or greater and 150 nm or less, and particularly preferably 15 nm or greater and 100 nm or less. Furthermore, a thickness of the second layer is preferably 10 nm or greater and 200 nm or less, more preferably 15 nm or greater and 150 nm or less, and particularly preferably 15 nm or greater and 150 nm or less.

### Organic Compound Layer on Surface of Composite Particles

In one embodiment, the composite particles may include an organic compound layer on a surface thereof. The organic compound that forms the organic compound layer is present on the surface of the composite particles and has a function of adjusting the physical properties of the surface of the composite particles. For example, when the composite particles include an organic compound on the surface, the composite particles have an improved affinity for a resin and, therefore, maximally exhibit a function of the alumina particles as a filler.

Examples of the organic compound include, but are not limited to, organosilanes, alkyl phosphoric acids, and polymers.

Examples of the organosilanes include alkyl trimethoxysilanes and alkyl trichlorosilanes in which the alkyl group has 1 to 22 carbon atoms, such as methyltrimethoxysilane, dimethyldimethoxysilane, ethyltrimethoxysilane, ethyltriethoxvsilane, n-propyitrimethoxysilane, n-propyltriethoxvsilane, isopropyltrimethoxysilane, isopropyltriethoxysilane, pentyltrimethoxysilane, and hexyltrimethoxysilane, trimethoxy(3,3,3-trifluoropropyl)silane, (tridecafluoro-1,1,2,2-tetrahydrooctyl)trichlorosilane, phenyltrimethoxysilane, phenyitriethoxysilane, p-(chloromethyl)phenyltrimethoxysilane, and p-(chloromethyl)phenyltriethoxysilane.

Examples of the phosphonic acids include methylphosphonic acid, ethylphosphonic acid, propylphosphonic acid, butylphosphonic acid, pentylphosphonic acid, hexylphosphonic acid, heptylphosphonic acid, octylphosphonic acid, decylphosphonic acid, dodecylphosphonic acid, octadecylphosphonic acid, 2-ethylhexylphosphonic acid, cyclohexyl methylphosphonic acid, cyclohexyl ethylphosphonic acid, benzylphosphonic acid, phenylphosphonic acid, and dodecyl benzene phosphonic acid.

Suitable examples of the polymers include poly(meth)acrylates. Specifically, examples of the polymers include polymethyl(meth)acrylate, polyethyl(meth)acrylate, polybutyl(meth)acrylate, polybenzyl(meth)acrylate, polycyclohexyl(meth)acrylate, poly(t-butyl(meth)acrylate), polyglycidyl(meth)acrylate, and polypentafluoropropyl(meth)acrylate, and further examples include general-purpose polymers, such as polystyrene, polyvinyl chloride, polyvinyl acetate, epoxy resins, polyesters, polyimides, and polycarbonates.

Note that one of the organic compounds mentioned above may be present alone, or two or more thereof may be present.

The form in which the organic compound is present is not particularly limited. The organic compound may be covalently bonded to the alumina and/or may cover the alumina and/or the material of the inorganic coating.

A content of the organic compound is preferably less than or equal to 20 mass % and more preferably 0.01 mass % or greater and 10 mass % or less, relative to the mass of the alumina particles. When the content of the organic compound is less than or equal to 20 mass %, the physical properties derived from the composite particles can be easily exhibited, and, therefore, such a content is preferable.

### Method for Producing Composite Particles

An example of a method for producing the composite particles of the first embodiment will now be described in detail. The method for producing the composite particles of the embodiment is not limited to the method for producing the composite particles described below.

The method for producing the composite particles of the embodiment includes a step of producing alumina particles by sintering a mixture that includes an aluminum compound, a molybdenum compound, and a shape control agent for controlling the shape of the alumina particles, the aluminum compound containing elemental aluminum, the molybdenum compound containing elemental molybdenum; and a step of forming an inorganic coating on a surface of the alumina particles, the inorganic coating including a composite metal oxide.

### Method for Producing Flaky Alumina Particles

Methods for producing the flaky alumina particles that form the composite particles are not particularly limited, and any known technique may be employed appropriately.

Preferably, a production method based on a flux method that utilizes a molybdenum compound may be employed because with such a method, alumina having a high degree of a crystallization can be suitably produced at a relatively low temperature.

More specifically, a preferred method for producing the flaky alumina particles includes a step (firing step) of firing an aluminum compound in the presence of a molybdenum compound and a shape control agent. The firing step may be a step of firing a mixture resulting from a step (mixing step) of obtaining the mixture to be fired.

### Mixing Step

The mixing step is a step of mixing an aluminum compound, a molybdenum compound, and a shape control agent together to form a mixture. It is preferable that the mixture further include a potassium compound. Details of the mixture will be described below.

### Aluminum Compound

The aluminum compound is a raw material for the flaky alumina particles of the embodiment. The aluminum compound is not particularly limited provided that the aluminum compound is converted to alumina when subjected to heat treatment. Examples of the aluminum compound include aluminum chloride, aluminum sulfate, basic aluminum acetate, aluminum hydroxide, boehmite, pseudoboehmite, transition alumina (e.g., γ-alumina, 5-alumina, and @ alumina), α-alumina, and mixed aluminas having two or more crystal phases. The physical forms of any of these aluminum compounds used as a precursor, such as a shape, a particle diameter, and a specific surface area, are not particularly limited.

In the flux method to be described in detail later, the shape of the aluminum compound may be any suitable shape, examples of which include spherical shapes, amorphous shapes, shapes of structures having a high aspect ratio (e.g., wires, fibers, ribbons, and tubes), and sheet shapes.

Similarly, in the flux method to be described in detail later, the aluminum compound may be a suitable solid aluminum compound, and the particle diameter thereof may range from several nanometers to several hundred micrometers.

Also, the specific surface area of the aluminum compound is not particularly limited. It is preferable that the specific surface area be high because in such a case, the molybdenum compound acts effectively. However, by adjusting firing conditions and/or an amount of usage of the molybdenum compound, an aluminum compound having any specific surface area can be used as a raw material.

Furthermore, the aluminum compound may be a compound exclusively including an aluminum compound or may be a composite material including an aluminum compound and an organic compound. Suitable examples thereof include organic-inorganic composite materials obtained by modifying an aluminum compound with an organosilane and composite materials of an aluminum compound including a polymer adsorbed thereon. In a case where a composite material such as those described above is used, a content of the organic compound is not particularly limited. From the standpoint of efficiently producing the flaky alumina particles, it is preferable that the content be less than or equal to 60 mass %; more preferably, the content is less than or equal to 30 mass %.

### Shape Control Agent

A shape control agent may be used to form the flaky alumina particles of the embodiment. The shape control agent plays an important role in the growth of the flaky crystals of the alumina in the firing of the aluminum compound in the presence of the molybdenum compound.

A state of existence of the shape control agent is not particularly limited. Examples of suitable materials include a material in which the shape control agent is physically mixed with the aluminum compound; and a composite material in which the shape control agent is uniformly or locally present on a surface of the aluminum compound or in an inner portion thereof.

Furthermore, the shape control agent may be added to the aluminum compound and/or may be present as an impurity in the aluminum compound.

The shape control agent plays an important role in the growth of the flaky crystals. In a molybdenum oxide flux method, molybdenum oxide reacts with an aluminum compound to form aluminum molybdate, and then, in the process in which the aluminum molybdate decomposes, a chemical potential changes, which is a driving force for crystallization; accordingly, hexagonal bipyramidal polyhedral particles having developed euhedral faces (11) are formed. In the production method according to an embodiment, presumably, the growth of the euhedral faces (113) is significantly inhibited because in the process in which the α-alumina grows, the shape control agent is localized in a region near the surface of the particles, and, consequently, the growth in a crystal orientation in a planar direction becomes relatively fast, which results in the growth of the (001) face or the (006) face and thus the formation of the flaky morphology. The use of a molybdenum compound as a fluxing agent facilitates the formation of flaky alumina particles containing molybdenum and having a high degree of α crystallization.

Note that the mechanism described above is based only on speculation, and, therefore, in cases where effects of the present invention are produced by a mechanism different from the mechanism described above, such cases are also included in the technical scope of the present invention.

Regarding the type of the shape control agent, it is preferable to use at least one selected from the group consisting of silicon, silicon compounds, and germanium compounds, from the standpoint of producing flaky alumina particles that have a higher aspect ratio and higher dispersibility and provide higher productivity. Silicon or a silicon compound may be used in combination with a germanium compound. Silicon or a silicon compound that contains elemental silicon can be a source of Si of mullite and, therefore, enables efficient production of mullite; in this regard, it is preferable to use, as a shape control agent, silicon or a silicon compound that contains elemental silicon. In a case where a germanium compound is used, flaky alumina particles having a higher aspect ratio and a larger particle diameter can be produced than in a case where silicon or a silicon compound is used; in this regard, it is preferable to use a germanium compound as a shape control agent.

In a case where silicon or a silicon compound is used as a shape control agent in the flux method described above, flaky alumina particles including mullite in the surface layer thereof can be easily produced.

In a case where a raw material germanium compound is used as a shape control agent in the flux method described above, flaky alumina particles containing germanium or a germanium compound can be easily produced.

### Silicon or Silicon Compound

The silicon or the silicon compound that contains elemental silicon is not particularly limited and may be a known material. Specific examples of the silicon or the silicon compound that contains elemental silicon include silicon metals; artificial/synthetic silicon compounds, such as organosilanes, silicone resins, silica microparticles, silica gels, mesoporous silicas, SiC, and mullite; and natural silicon compounds, such as biogenic silicas. Of these, it is preferable to use one or more of an organosilane, a silicone resin, and silica microparticles because these materials can be more uniformly combined and mixed with the aluminum compound. Note that silicon or a silicon compound that contains elemental silicon may be used alone, or two or more of silicon and silicon compounds may be used in combination. Furthermore, one or more other shape control agents may be used additionally provided that the effects of the present invention are not impaired.

A shape of the silicon or the silicon compound that contains elemental silicon is not particularly limited, and suitable examples of the shape include spherical shapes, amorphous shapes, shapes of structures having a high aspect ratio (e.g., wires, fibers, ribbons, and tubes), and sheet shapes.

### Germanium Compound

The raw material germanium compound used as a shape control agent is not particularly limited and may be a known material. Specific examples of the raw material germanium compound include germanium metal, germanium dioxide, germanium monoxide, germanium tetrachloride, and organic germanium compounds having a Ge—C bond. Note that one raw material germanium compound may be used alone, or two or more raw material germanium compounds may be used in combination. Furthermore, one or more other shape control agents may be used additionally provided that the effects of the present invention are not impaired.

A shape of the raw material germanium is not particularly limited, and suitable examples of the shape include spherical shapes, amorphous shapes, shapes of structures having a high aspect ratio (e.g., wires, fibers, ribbons, and tubes), and sheet shapes.

### Molybdenum Compound

The molybdenum compound functions as a fluxing agent in the growth of the α crystal of the alumina as will be described later. Examples of the molybdenum compound include, but are not limited to, molybdenum oxide and compounds containing acid group anions (MoOₓⁿ⁻) in which molybdenum metal is bonded to oxygen.

Examples of the compound containing acid group anions (MoOₓⁿ⁻) include, but are not limited to, molybdic acid, sodium molybdate, potassium molybdate, lithium molybdate, H₃PMo₁₂O₄₀, H₃SiMo₁₂O₄₀, NH₄Mo₇O₁₂, and molybdenum disulfide.

The molybdenum compound may contain silicon, and in this case, the molybdenum compound containing silicon serves both as a fluxing agent and as a shape control agent.

Of the molybdenum compounds mentioned above, it is preferable to use molybdenum oxide, from the standpoint of cost and ease of sublimation. One of the molybdenum compounds mentioned above may be used alone, or two or more thereof may be used in combination.

Potassium molybdate (K₂MoₙO₃ₙ₊₁, n=1 to 3) contains potassium and, therefore, can also have functions of the potassium compound to be described below. In the production method of the embodiment, “using potassium molybdate as a fluxing agent” has the same meaning as “using a molybdenum compound and a potassium compound as fluxing agents”.

### Potassium Compound

Together with the shape control agent, a potassium compound may be additionally used.

Examples of the potassium compound include, but are not limited to, potassium chloride, potassium chlorite, potassium chlorate, potassium sulfate, potassium hydrogen sulfate, potassium sulfite, potassium bisulfite, potassium nitrate, potassium carbonate, potassium hydrogen carbonate, potassium acetate, potassium oxide, potassium bromide, potassium bromate, potassium hydroxide, potassium silicate, potassium phosphate, potassium hydrogen phosphate, potassium sulfide, potassium hydrogen sulfide, potassium molybdate, and potassium tungstate. As mentioned herein, the potassium compounds include isomers, as in the case of the molybdenum compound. Of these, it is preferable to use one or more of potassium carbonate, potassium hydrogen carbonate, potassium oxide, potassium hydroxide, potassium chloride, potassium sulfate, and potassium molybdate, and it is more preferable to use one or more of potassium carbonate, potassium hydrogen carbonate, potassium chloride, potassium sulfate, and potassium molybdate.

One of the potassium compounds mentioned above may be used alone, or two or more thereof may be used in combination.

The potassium compound contributes to efficient formation of mullite in the surface layer of the alumina. Furthermore, the potassium compound contributes to efficient formation of a germanium-containing layer in the surface layer of the alumina.

Furthermore, it is also preferable that the potassium compound be used as a fluxing agent, together with the molybdenum compound.

Of the potassium compounds mentioned above, potassium molybdate contains molybdenum and, therefore, can also have functions of the molybdenum compound described above. Using potassium molybdate as a fluxing agent produces an effect similar to that produced by using a molybdenum compound and a potassium compound as fluxing agents.

The potassium compound used as a raw material to be loaded or the potassium compound formed in a reaction in the heating process of firing may be a water-soluble potassium compound, which may be, for example, potassium molybdate. In this case, since potassium molybdate does not vaporize even in a firing temperature range and can be easily recovered by washing after firing, the amount of the molybdenum compound that is released to the outside of the firing furnace is reduced, and the production cost is significantly reduced.

In a case where a molybdenum compound and a potassium compound are used as fluxing agents, the molar ratio of the elemental molybdenum of the molybdenum compound to the elemental potassium to the potassium compound (elemental molybdenum/elemental potassium) is preferably less than or equal to 5 and more preferably 0.01 to 3; even more preferably, the molar ratio is 0.5 to 1.5 because in this case, the cost of production can be further reduced. When the molar ratio (elemental molybdenum/elemental potassium) is within any of the above-mentioned ranges, flaky alumina particles having a large particle size can be obtained, and, therefore, such a molar ratio is preferable.

### Metal Compound

As will be described below, a metal compound can have a function of promoting the growth of crystals of the alumina. The metal compound may be used in firing as desired. Note that the metal compound may be used to promote the growth of crystals of the α-alumina but is not essential in the production of the flaky alumina particles of the present invention.

The metal compound is not particularly limited and is preferably a metal compound containing at least one metal selected from the group consisting of the metals of Group II and the metals of Group III.

Examples of metal compounds containing at least one metal of Group II include magnesium compounds, calcium compounds, strontium compounds, and barium compounds.

Examples of metal compounds containing at least one metal of Group III include scandium compounds, yttrium compounds, lanthanum compounds, and cerium compounds.

Note that the term “metal compound.”, as mentioned above, refers to oxides, hydroxides, carbonates, and chlorides of any metal element. For example, yttrium compounds include yttrium oxide (Y₂O₃), yttrium hydroxide, and yttrium carbonate. Of the metal compounds mentioned above, oxides of a metal element are preferred metal compounds. Note that as mentioned herein, the metal compounds include isomers.

Of the metal compounds mentioned above, compounds of Period 3 metal elements, compounds of Period 4 metal elements, compounds of Period. 5 metal elements, and compounds of Period 6 metal elements are preferable; compounds of Period 4 metal elements and compounds of Period 5 metal elements are more preferable; and compounds of Period 5 metal elements are even more preferable. Specifically, it is preferable to use one or more of a magnesium compound, a calcium compound, a yttrium compound, and a lanthanum compound; it is more preferable to use one or more of a magnesium compound, a calcium compound, and a yttrium compound; and it is particularly preferable to use a yttrium compound.

A ratio of addition of the metal compound is preferably 0.02 to 20 mass % and more preferably 0.1 to 20 mass %, relative to an amount the elemental aluminum in the aluminum compound in terms of a mass. When the ratio of addition of the metal compound is greater than or equal to 0.02 mass %, the growth of crystals of the molybdenum-containing α-alumina can proceed suitably, and, therefore, such a ratio of addition is preferable. On the other hand, when the ratio of addition of the metal compound is less than or equal to 20 mass %, flaky alumina particles having a low content of metal-compound-derived impurities can be obtained, and, therefore, such a ratio of addition is preferable.

### Yttrium

In a case where the aluminum compound is fired in the presence of a yttrium compound used as the metal compound, the growth of crystals proceeds more suitably in the firing step, and, consequently, α-alumina and a water-soluble yttrium compound are formed. In this instance, the water-soluble yttrium compound tends to be localized on the surface of the α-alumina, that is, the flaky alumina particles; therefore, if necessary, by carrying out washing with water, alkaline water, a liquid obtained by heating any of these, or the like, the yttrium compound can be removed from the flaky alumina particles.

Amounts of usage of the aluminum compound, the molybdenum compound, the silicon or silicon compound, the germanium compound, the potassium compound, and the like are not particularly limited. For example, the following mixture may be subjected to firing, with the amounts being based on the total mass of the raw materials (calculated as oxides) taken as 100 mass %:

1) a mixture in which an aluminum compound, a molybdenum compound, and silicon or a silicon compound, or, a germanium compound are mixed together, the aluminum compound being preferably in an amount greater than or equal to 50 mass %, more preferably in an amount of 70 mass % or greater and 99 mass % or less, and even more preferably in an amount of 80 mass % or greater and 94.5 mass % or less, calculated as Al₂O₃, the molybdenum compound being preferably in an amount less than or equal to 40 mass %, more preferably in an amount of 0.5 mass % or greater and 20 mass % or less, and even more preferably in an amount of 1 mass % or greater and 7 mass % or less, calculated as MoO₃, the silicon or silicon compound, or, the germanium compound being preferably in an amount of 0.1 mass % or greater and 10 mass % or less, more preferably in an amount of 0.5 mass % or greater and less than 7 masse, and even more preferably in an amount of 0.8 mass % or greater and 4 mass % or less, calculated as SiO₂ or GeO₂.

From the standpoint of obtaining flaky alumina particles having a larger particle diameter, it is preferable that the molybdenum compound be used in the mixture in an amount of 7 mass % or greater and 40 mass % or less, calculated as MoO₃; more preferably, the amount is 9 mass % or greater and 30 mass % or less, and even more preferably, 10 mass % or greater and 17 mass % or less.

From the standpoint of obtaining flaky alumina particles having a larger particle diameter, it is preferable that the silicon or silicon compound, or, the germanium compound be used in the mixture in an amount of 0.4 mass % or greater and less than 10 mass %, calculated as SiO₂ and/or GeO₂; more preferably, the amount is 0.5 mass % or greater and 10 mass % or less, and particularly preferably, 1 mass % or greater and 3 mass % or less.

The silicon or silicon compound and/or the germanium compound used as shape control agents may be silicon or a silicon compound or a germanium compound.

Regarding the shape control agent, silicon or a silicon compound may be exclusively used, a germanium compound may be exclusively used, or a combination of silicon or a silicon compound and a germanium compound may be used in a case where a germanium compound is used as a shape control agent, the germanium compound to be included in the mixture may be preferably in an amount of 0.4 mass % or greater and less than 1.5 mass % and more preferably 0.7 mass % or greater and 1.2 mass % or less, calculated as GeO₂, with the amounts being based on the total mass of the raw materials (calculated as oxides) taken as 100 mass %.

The above-described conditions of the raw material amounts (mass %) may be freely combined for the raw materials, and the lower limit and the upper limit of each of the raw material amounts (mass %) may also be freely combined.

In cases where the various compounds are used within any of the above-mentioned ranges, flaky alumina particles that satisfy the value of the (006/113) ratio mentioned above and, therefore, have excellent luminescent properties can be easily produced.

In a case where the mixture further includes the potassium compound, the amount of usage of the potassium compound is not particularly limited, and the potassium compound to be mixed may be preferably in an amount less than or equal to 5 mass %, more preferably in an amount of 0.01 mass % or greater and 3 mass % or less, and even more preferably in an amount of 0.05 mass % or greater and 1 mass % or less, calculated as K₂O, with the amounts being based on the total mass of the raw materials (calculated as oxides) taken as 100 mass %.

Presumably, in a case where a potassium compound is used, potassium molybdate, which is formed by a reaction with the molybdenum compound, has an effect of diffusing Si and, accordingly, contributes to promoting the formation of mullite in the surface of the flaky alumina particles. Likewise, presumably, in a case where a potassium compound is used, potassium molybdate, which is formed by a reaction with the molybdenum compound, has an effect of diffusing the raw material germanium and, accordingly, contributes to promoting the inclusion of germanium or a germanium compound in the surface of the flaky alumina particles. The potassium compound used as a raw material to be loaded or the potassium compound formed in a reaction in the heating process of firing may be a water-soluble potassium compound, which may be, for example, potassium molybdate. In this case, since potassium molybdate does not vaporize even in a firing temperature range and can be easily recovered by washing after firing, the amount of the molybdenum compound that is released to the outside of the firing furnace is reduced, and the production cost is significantly reduced.

In a flux method, it is also preferable to use a molybdenum compound and a potassium compound as fluxing agents. Note that a compound containing molybdenum and potassium, which may be used as a fluxing agent, can be produced in the process of firing, for example, by using, as raw materials, a molybdenum compound and a potassium compound, which are less expensive and can be procured easily. Herein, the descriptions are made regarding instances presented as examples, in which a molybdenum compound and a potassium compound are used as fluxing agents, the instances including both instances in which a molybdenum compound and a potassium compound are used as fluxing agents and instances in which a compound containing molybdenum and potassium is used as a fluxing agent.

From the standpoint of obtaining flaky alumina particles having an even larger particle size, the following mixture may be used, with the amounts of usage of the aluminum compound, the molybdenum compound, the potassium compound, and the silicon or silicon compound being preferably as follows, based on the total mass of the raw materials (calculated as oxides) taken as 100 mass %:

2) a mixture in which an aluminum compound, a molybdenum compound, a potassium compound, and silicon or a silicon compound are mixed together, the aluminum compound being in an amount greater than or equal to 10 mass %, calculated as Al₂O₃, the molybdenum compound being in an amount greater than or equal to 20 mass %, calculated as MoO₃, the potassium compound being in an amount greater than or equal to 1 mass %, calculated as K₂O, the silicon or silicon compound being in an amount less than 1 mass %, calculated as SiO_{2.}

From the standpoint of increasing a content of hexagonal, flaky alumina, the following mixture may be more preferably used, with the amounts being based on the total mass of the raw materials (calculated as oxides) taken as 100 mass %.

3) a mixture in which an aluminum compound, a molybdenum compound, a potassium compound, and silicon or a silicon compound are mixed together, the aluminum compound being in an amount of 20 mass % or greater and 70 mass % or less, calculated as Al₂O₃, the molybdenum compound being in an amount of 30 mass % or greater and 80 mass % or less, calculated as MoO₃, the potassium compound being in an amount of 5 mass % or greater and 30 mass % or less, calculated as K₂O, the silicon or silicon compound being in an amount of 0.001 mass % or greater and 0.3 mass % or less, calculated as SiO₂.

From the standpoint of increasing the content of hexagonal, flaky alumina, the following mixture may be even more preferably used, with the amounts being based on the total mass of the raw materials (calculated as oxides) taken as 100 mass %.

4) a mixture in which an aluminum compound, a molybdenum compound, a potassium compound, and silicon or a silicon compound are mixed together, the aluminum compound being in an amount of 25 mass % or greater and 40 mass % or less, calculated as Al₂O₃, the molybdenum compound being in an amount of 45 mass % or greater and 70 mass % or less, calculated as MoO₃, the potassium compound being in an amount of 10 mass % or greater and 20 mass % or less, calculated as K₂O, the silicon or silicon compound being in an amount of 0.01 mass % or greater and 0.1 mass % or less, calculated as SiO₂.

To maximally increase the content of hexagonal, flaky alumina and enable the growth of crystals to proceed more suitably, the following mixture may be particularly preferably used, with the amounts being based on the total mass of the raw materials (calculated as oxides) taken as 100 mass %.

5) a mixture in which an aluminum compound, a molybdenum compound, a potassium compound, and silicon or a silicon compound are mixed together, the aluminum compound being in an amount of 35 mass % or greater and 40 mass % or less, calculated as Al₂O₃, the molybdenum compound being in an amount of 45 mass % or greater and 65 mass % or less, calculated as MoO₃, the potassium compound being in an amount of 10 mass % or greater and 20 mass % or less, calculated as K₂O, the silicon or silicon compound being in an amount of 0.02 mass % or greater and 0.08 mass % or less, calculated as SiO₂.

In cases where the various compounds are included within any of the above-mentioned ranges, flaky alumina particles that are flaky and have a large particle size and which have higher luminescent properties can be produced. In particular, in cases where the amount of usage of molybdenum tends to be increased, and the amount of usage of silicon tends to be reduced to some extent, the particle size and a crystallite diameter can be increased, and hexagonal, flaky alumina particles can be easily produced; and in cases where the various compounds are included within any of the more preferable ranges mentioned above, hexagonal, flaky alumina particles tend to be easily produced, and the content thereof tends to be further increased, and the luminescent properties of the resulting alumina particles tend to be higher.

In a case where the mixture further includes a yttrium compound, the amount of usage of the yttrium compound is not particularly limited; the yttrium compound may be mixed, preferably in an amount less than or equal to 5 mass % and more preferably in an amount of 0.01 mass % or greater and 3 mass % or less, calculated as Y₂O₃, with the amounts being based on the total mass of the raw materials (calculated as oxides) taken as 100 mass %. To enable the growth of crystals to proceed more suitably, the yttrium compound may be mixed even more preferably in an amount of 0.1 mass % or greater and 1 mass % or less, calculated as Y₂O₃, with the amounts being based on the total mass of the raw materials (calculated as oxides) taken as 100 mass %.

The numerical values of the amounts of usage of the raw materials may be appropriately combined within the range in which the total content of the raw materials does not exceed 1.00 mass %.

### Firing Step

The firing step is a step of firing an aluminum compound in the presence of a molybdenum compound and a shape control agent. The firing step may be a step of firing the mixture resulting from the mixing step.

The flaky alumina particles can be obtained, for example, by firing an aluminum compound in the presence of a molybdenum compound and a shape control agent. This production method is called a flux method as stated above.

The flux method is classified as a solution method. More specifically, the flux method is a method for growing crystals utilizing an instance in which a crystal-flux binary phase diagram is of a eutectic type. It is speculated that the mechanism of the flux method is as follows. Specifically, as a mixture of a solute and flux is heated, the solute and the flux form a liquid phase. In this case, since the flux is a fusing agent, that is, the solute-flux binary phase diagram is of a eutectic type, the solute melts at a temperature lower than its melting point to form the liquid phase. When the flux is evaporated in this state, the concentration of the flux decreases, that is, the effect of the flux of decreasing the melting point of the solute is reduced, and thus, the evaporation of the flux serves as a driving force to cause the growth of crystals of the solute (flux evaporation method). Note that the growth of crystals of the solute can also be caused by cooling the liquid phase of the solute and the flux (slow cooling method).

The flux method has advantages. For example, the growth of crystals can be achieved at temperatures much lower than a melting point; crystal structures can be precisely controlled; and a polyhedral crystal body having a euhedral shape can be formed.

The mechanism by which α-alumina particles are produced by a flux method that uses a molybdenum compound as flux is not necessarily clear. However, for example, it is speculated that the mechanism is as follows. Specifically, when an aluminum compound is fired in the presence of a molybdenum compound, aluminum molybdate is first formed. In this case, the crystal of α-alumina grows from the aluminum molybdate at temperatures lower than the melting point of alumina, as will be appreciated from the description above. Then, for example, through decomposition of the aluminum molybdate, evaporation of the flux, and the like, the growth of crystals is accelerated, and, accordingly, alumina particles can be obtained. That is, the molybdenum compound serves as flux, and, via the aluminum molybdate, which is an intermediate product, the α-alumina particles are produced.

The mechanism by which α-alumina particles are produced by a flux method in a case where a potassium compound is additionally used as a fluxing agent is not necessarily clear. However, for example, it is speculated that the mechanism is as follows. First, the molybdenum compound and the aluminum compound react with each other to form aluminum molybdate. Then, for example, the aluminum molybdate decomposes into molybdenum oxide and alumina, and also, a molybdenum compound that contains the molybdenum oxide resulting from the decomposition reacts with the potassium compound to form potassium molybdate. The crystals of alumina grow in the presence of the molybdenum compound that contains the potassium molybdate, and, consequently, the flaky alumina particles of the embodiment can be obtained.

By using the flux method described above, flaky alumina particles that satisfy the value of the (006/113) ratio mentioned above and, therefore, have excellent luminescent properties can be produced.

Methods for the firing are not particularly limited, and any known, ordinary method may be used for the firing. When a firing temperature exceeds 700° C., the aluminum compound reacts with the molybdenum compound to form aluminum molybdate. Furthermore, when the firing temperature reaches 900° C. or higher, the aluminum molybdate decomposes, and, under the action of the shape control agent, the flaky alumina particles are formed.

Furthermore, presumably, when the aluminum molybdate decomposes into alumina and molybdenum oxide, a molybdenum compound is incorporated into particles of the aluminum oxide in the flaky alumina particles.

Furthermore, presumably, when the firing temperature reaches 900° C. or higher, the molybdenum compound (e.g., molybdenum trioxide) resulting from the decomposition of the aluminum molybdate reacts with the potassium compound to form potassium molybdate.

Furthermore, presumably, when the firing temperature reaches 1000° C. or higher, the crystals of the flaky alumina particles grow in the presence of molybdenum, and Al₂O₃ and SiO₂ in the surface of the flaky alumina particles react with each other to form mullite with high efficiency. Likewise, presumably, when the firing temperature reaches 1000° C. or higher, the crystals of the flaky alumina particles grow in the presence of molybdenum, and Al₂O₃ and a Ge compound in the surface of the flaky alumina particles react with each other to form germanium dioxide, a compound containing Ge—O—Al, and/or the like with high efficiency.

Furthermore, in the firing, the states of the aluminum compound, the shape control agent, and the molybdenum compound are not particularly limited, and it is sufficient that the aluminum compound, the shape control agent, and the molybdenum compound be present in the same space such that the molybdenum compound and the shape control agent can act on the aluminum compound. Specifically, any of the following may be employed: simple mixing in which powders of the molybdenum compound, the shape control agent, and the aluminum compound are mixed together, mechanical mixing using a mill or the like, and mixing using a mortar or the like; and either of dry mixing and wet mixing may be employed.

The conditions of the firing temperature are not particularly limited and are appropriately determined in consideration of the value of the (006/113) ratio mentioned above, the average particle diameter, the aspect ratio, the formation of mullite, the value of the longitudinal relaxation time T₁ mentioned above, the dispersibility, and the like of the target flaky alumina particles. Typically, with regard to the temperature for the firing, the maximum temperature is preferably higher than or equal to 900° C., which is a decomposition temperature of aluminum molybdate (Al₂(MoO₄)₃), more preferably higher than or equal to 1000° C., at which mullite and a germanium compound are formed with high efficiency, and even more preferably higher than or equal to 1200° C., at which flaky alumina particles having a longitudinal relaxation time T₁ of greater than or equal to 5 seconds (having high crystallinity) can be easily obtained.

In general, controlling the shape of α-alumina that results from firing requires the implementation of high-temperature firing at higher than or equal to 2000° C., which is close to the melting point of α-alumina. However, industrial application of such high-temperature firing involves significant problems in terms of the load on the firing furnace and the fuel cost.

The production method of the embodiment can be implemented even at a high temperature of higher than 2000° C.; however, even at a temperature of 1600° C. or lower, which is much lower than the melting point of α-alumina, the production method can form α-alumina having a flaky shape with a high degree of α crystallization and a high aspect ratio, regardless of the shape of the precursor.

According to one embodiment of the present invention, flaky alumina particles having a high aspect ratio and a degree of α crystallization of 90% or greater can be formed efficiently at low cost even under the condition of a maximum firing temperature of 900 to 1600° C. Firing in which the maximum temperature is 950 to 1500° C. is more preferable, firing in which the maximum temperature is 1000 to 1400° C. is even more preferable, and firing in which the maximum temperature is 1200 to 1400° C. is most preferable.

With regard to a time for the firing, it is preferable that the time for increasing the temperature to a predetermined maximum temperature be within a range of 15 minutes to 10 hours, and holding be carried out at a maximum Firing temperature for 5 minutes to 30 hours. In terms of efficiently forming the flaky alumina particles, it is more preferable that the firing holding time be approximately 10 minutes to 15 hours.

In a case where the conditions of the maximum temperature of 1000 to 1400° C. and the Firing holding time of 10 minutes to 15 hours are selected, alumina particles having a polygonal flake shape with a dense α-crystalline form can be easily obtained while the formation of aggregates is inhibited.

In a case where the conditions of the maximum temperature of 1200 to 1400° C. and the firing holding time of 10 minutes to 1.5 hours are selected, flaky alumina particles having a longitudinal relaxation time T₁ of greater than or equal to 5 seconds (having high crystallinity) can be easily obtained.

Atmospheres for the firing are not particularly limited provided that the effects of the present invention can be produced. For example, oxygen-containing atmospheres, such as air and oxygen, and inert atmospheres, such as nitrogen, argon, and carbon dioxide, are preferable, and, when cost is taken into consideration, air atmospheres are more preferable.

Apparatuses for performing the firing are also not necessarily limited, and a so-called firing furnace may be used. It is preferable that the Firing furnace be formed of a material that does not react with sublimed molybdenum oxide, and it is further preferable that a gas-tight firing furnace be used to efficiently utilize the molybdenum oxide.

When the alumina particles are to be obtained, it is preferable to obtain the alumina particles by firing an aluminum compound in the presence of a molybdenum compound and a shape control agent or in the presence of a molybdenum compound, a shape control agent, a potassium compound, and a metal oxide.

That is, a preferred method for producing the alumina particles includes a step (firing step) of firing an aluminum compound in the presence of a molybdenum compound and a shape control agent or in the presence of a molybdenum compound, a shape control agent, and a potassium compound. It is preferable that the mixture further include a metal compound as described above. It is preferable that the metal compound be a yttrium compound.

In a flux method that uses a molybdenum compound, molybdenum oxide reacts with an aluminum compound to form aluminum molybdate, and then, in the process in which the aluminum molybdate decomposes, a chemical potential changes, which is a driving force for crystallization; accordingly, hexagonal bipyramidal polyhedral particles having developed euhedral faces (113) are formed. It is inferred that, in the production method according to an embodiment, the growth of the euhedral faces (113) is significantly inhibited because in the process in which the α-alumina grows, the shape control agent is localized in a region near the surface of the particles, and, consequently, the growth in a crystal orientation in a planar direction becomes relatively fast, which results in the growth of the (001) face or the (006) face and thus the formation of the flaky morphology. Accordingly, the use of a molybdenum compound as a fluxing agent facilitates the formation of flaky alumina particles containing molybdenum and having a high degree of α crystallization.

### Cooling Step

In a case where a molybdenum compound and a potassium compound are used as fluxing agents, the method for producing the alumina particles may include a cooling step. The cooling step is a step of cooling the alumina resulting from the growth of crystals achieved in the Firing step. More specifically, the cooling step may be a step of cooling a composition resulting from the firing step, the composition including the alumina and the fluxing agent, which is in a liquid phase.

A cooling rate is not particularly limited and is preferably 1 to 1000° C./hour, more preferably 5 to 500° C./hour, and even more preferably 50 to 100° C./hour. When the cooling rate is greater than or equal to 1° C./hour, the production time can be shortened, and, therefore, such a cooling rate is preferable. On the other hand, when the cooling rate is less than or equal to 1000° C./hour, the crucible for the firing is less susceptible to cracking due to heat shock and, therefore, can be used for a long period of time; accordingly, such a cooling rate is preferable.

Methods for the cooling are not particularly limited, and the cooling may be carried out by natural cooling or by using a cooling device.

### Post-Treatment Step

The method for producing the flaky alumina particles of the embodiment may include a post-treatment step. The post-treatment step is a post-treatment step for the flaky alumina particles and a step for removing the fluxing agent. The post-treatment step may be performed after the firing step, after the cooling step, or after the firing step and after the cooling step. If necessary, the post-treatment step may be performed repeatedly, two or more times.

Examples of methods for the post-treatment include washing and high-temperature treatment. These may be performed in combination.

Methods for the washing are not particularly limited, and the washing may be carried out by using water, an aqueous ammonia solution, an aqueous sodium hydroxide solution, or an acidic aqueous solution, to remove the fluxing agent.

In this case, the content of molybdenum can be controlled by appropriately changing a concentration and an amount of usage of the water, aqueous ammonia solution, aqueous sodium hydroxide solution, or acidic aqueous solution to be used, an area to be washed, a washing time, and/or the like.

Examples of methods for the high-temperature treatment include performing heating to achieve a temperature higher than or equal to the sublimation temperature or boiling temperature of the flux.

### Pulverizing Step

In some cases, the fired product may include aggregates of flaky alumina particles, and, consequently, the particle diameter range suitable for the present invention may not be achieved. Accordingly, as necessary, the flaky alumina particles may be pulverized so that the particle diameter range suitable for the present invention can be achieved. Methods for pulverizing the fired product are not particularly limited. Any known pulverizing method using a ball mill, jaw crusher, jet mill, disc mill, SpectroMill, grinder, mixer mill, or the like may be employed.

### Size Classification Step

It is preferable that the flaky alumina particles be subjected to a size classification process. A purpose of the size classification is to adjust the average particle diameter to improve the flowability of a powder or to suppress a viscosity increase that may occur when the flaky alumina particles are added to a binder for forming a matrix. The term “size classification process” refers to an operation of sorting particles by particle size.

The size classification may be wet classification or dry classification, but, from the standpoint of productivity, dry classification is preferable. The dry classification may be classification using a sieve or may be, for example, air classification, in which classification is performed by using the difference between the centrifugal force and the fluid drag. From the standpoint of classification accuracy, air classification is preferable, and the air classification may be performed by using a classifier, such as an air sifter that utilizes a Coanda effect, a swirling airflow type classifier, a forced vortex centrifugal classifier, or a semi-free vortex centrifugal classifier. The pulverizing step and the size classification step described above may be performed at stages where the steps are necessary, the stages including the stages before and after an organic compound layer forming step, which will be described later. By selecting whether or not to perform the pulverizing and/or the size classification and/or selecting conditions therefor, the average particle diameter of the resulting flaky alumina particles, for example, can be adjusted.

It is preferable that the flaky alumina particles of the embodiment and the flaky alumina particles produced by the production method of the embodiment have few aggregates or no aggregates. This is because in such a case, their inherent properties can be easily exhibited, and the handleability thereof is enhanced, and enhanced dispersibility is exhibited in a case where the flaky alumina particles are used by being dispersed in a dispersion medium. In the method for producing flaky alumina particles, in a case where flaky alumina particles having few aggregates or no aggregates can be produced without performing the pulverizing step and/or the size classification step described above, these steps need not be performed. In this case, the target flaky alumina that has excellent properties can be produced with high productivity, and, accordingly, such a case is preferable.

### Inorganic Coating Forming Step

Next, an inorganic coating including a composite metal oxide is to be formed on the surface of the flaky alumina particles obtained as described above. Methods for forming the layer are not particularly limited. Examples of the methods include liquid phase methods and vapor phase methods.

As an inorganic chemical species that can form the inorganic coating, any of the inorganic chemical species mentioned above may be used.

The inorganic coating forming step includes, for example, a process in which a metal inorganic salt containing at least one metal other than aluminum (Al) is contacted with the flaky alumina particles, and then, the metal inorganic salt, which is deposited on the flaky alumina particles, is converted into a composite metal oxide.

Alternatively, the inorganic coating forming step may include another process, which includes a first conversion step and a second conversion step. In the first conversion step, a first metal inorganic salt containing at least one metal other than aluminum (Al) is contacted with the flaky alumina particles, and then, the first metal inorganic salt, which is deposited on the flaky alumina particles, is converted into a metal oxide or a composite metal oxide (hereinafter also referred to simply as a “metal oxide or the like”), and subsequently, in the second conversion step, a second metal inorganic salt is contacted with the metal oxide or the like and/or the flaky alumina particles, the second metal inorganic salt containing at least one different metal, which is a metal other than aluminum (Al) and different from the metal used in the first conversion step, and then, the metal oxide and/or the second metal inorganic salt are converted into a composite metal oxide.

The formation of the coating including a composite metal oxide on the alumina particles may be accomplished as follows. A liquid medium dispersion of molybdenum-containing alumina particles may be mixed with a composite metal oxide itself or a dispersion liquid thereof, and the mixture may be filtered and dried. In a case where it is desired to enhance interaction between the alumina particles and the composite metal oxide, thereby enabling particularly noticeably excellent properties to be exhibited, for example, in a case where, as described above, enhanced coating characteristics are desired, a more uniform inorganic coating is desired, and/or a reduced probability of delamination of the resulting inorganic coating from the alumina particles is desired, the inorganic coating may be formed as follows, preferably. A solution of a first metal inorganic salt that has solubility for a liquid medium, the first metal inorganic salt being the precursor of a metal oxide, may be mixed with the molybdenum-containing alumina particles or with a liquid medium dispersion thereof to cause the first metal inorganic salt, which is dissolved and in a molecular form, to be sufficiently contacted with the molybdenum-containing alumina particles, and then, the first metal inorganic salt, which is deposited on the alumina particles and having a very small size of less than or equal to 150 nm, may be converted into a metal oxide or the like.

Furthermore, preferably, a solution of a second metal inorganic salt that has solubility for a liquid medium may be mixed with the alumina particles on which the metal oxide or the like has been formed, or, with a liquid medium dispersion thereof, to cause the second metal inorganic salt, which is dissolved and in a molecular form, to be sufficiently contacted with the metal oxide or the like and/or the molybdenum-containing alumina particles, and then, the second metal inorganic salt, which is deposited on the metal oxide or the like and/or the molybdenum-containing alumina particles and which has a very small size of less than or equal to 150 nm, may be converted into a metal oxide or the like. Additionally, filtration and/or drying may be performed if necessary. For the conversion of the first metal inorganic salt into a metal oxide or the like and/or the conversion of the second metal inorganic salt into a metal oxide or the like, in a case where the conversion cannot be accomplished easily because of a low temperature or a change in pH, firing may be performed if necessary. In this case, a strong interaction between the alumina particles and the composite metal oxide, which is not present in a simple mixture, can be exhibited, and, therefore, particularly noticeably excellent properties as described above can be easily exhibited. For firing conditions for the step of forming the inorganic coating, optimal conditions may be appropriately selected and employed, with reference to the above-described conditions used for the alumina particles.

As a firing condition for the conversion of the first metal inorganic salt into a metal oxide or the like, a firing temperature of 600 to 1200° C., for example, may be selected. Furthermore, as a firing condition for the conversion of the second metal inorganic salt into a metal oxide or the like, a firing temperature of 600 to 1200° C., for example, may be selected. The conversion of the first metal inorganic salt into a metal oxide or the like and the conversion of the second metal inorganic salt into a metal oxide or the like may be carried out concurrently, for which firing may be performed at a temperature of 600 to 1200° C., for example.

Regarding the liquid phase methods, an example thereof is as follows. A dispersion in which the flaky alumina particles are dispersed is prepared, the dispersion is subjected to pH adjustment and heating as necessary, and subsequently, an aqueous solution of a first metal inorganic salt, such as cobalt sulfate, is added dropwise to the dispersion. In this instance, it is preferable that the pH be maintained at a constant level with an alkaline aqueous solution. Subsequently, the dispersion is stirred for a predetermined period of time, and the resultant is filtered, washed, and dried to obtain a powder. In this manner, a first inorganic coating formed of a metal oxide, such as cobalt oxide, is formed on the surface of the alumina particles having a flaky shape.

Next, a dispersion in which the flaky alumina particles on which the first inorganic coating has been formed are dispersed is prepared, the dispersion is subjected to pH adjustment and heating as necessary, and subsequently, an aqueous solution of a second metal inorganic salt, such as iron chloride, is added dropwise to the dispersion. In this instance, it is preferable that the pH be maintained at a constant level with an acidic aqueous solution. Subsequently, the dispersion is stirred for a predetermined period of time, and the resultant is filtered, washed, and dried to obtain a powder. In this manner, a second inorganic coating formed of, for example, aluminum-cobalt oxide and iron oxide is formed on the surface of the alumina particles having a flaky shape.

The inorganic coating may be formed of any of other composite metal oxides, examples of which include aluminum-cobalt oxide, aluminum-zinc oxide, aluminum-cobalt oxide and iron oxide, aluminum-cobalt oxide and titanium oxide, cobalt-iron oxide and iron oxide, zinc-iron oxide and zinc oxide, zinc-titanium oxide and zinc oxide, nickel-titanium oxide and nickel oxide, and manganese-iron oxide and iron oxide.

Additionally or alternatively, the inorganic coating may be formed of nickel-iron oxide or nickel-titanium oxide or manganese-iron oxide, or the inorganic coating may be formed of cobalt-titanium oxide and aluminum-cobalt oxide.

In the present step, the inorganic coating layer may be formed in a manner such that the inorganic coating layer covers at least a portion of the surface of the flaky alumina particles. In this case, the layer is formed in a state in which particles formed of a composite metal oxide are aggregated together, for example.

### Organic Compound Layer Forming Step

In one embodiment, the method for producing flaky alumina particles may further include an organic compound layer forming step, which is performed after the inorganic coating forming step to form an organic compound layer on a surface of the inorganic coating (also referred to as a “surface of the composite particles”). Typically, the organic compound layer forming step is performed after the firing step or after the post-treatment step.

Methods for forming the organic compound layer are not particularly limited, and a known method may be appropriately employed. Examples of the methods include a method in which a liquid including an organic compound is contacted with the molybdenum-containing flaky alumina particles and dried.

Note that the organic compound that may be used in the formation of the organic compound layer may be, for example, an organosilane compound.

### Organosilane Compound

In a case where the flaky alumina particles contain silicon atoms and/or an inorganic silicon compound, an effect of surface modification as described above can be expected compared with a case in which the flaky alumina particles do not contain silicon atoms or an inorganic silicon compound. Furthermore, a reaction product of an organosilane compound and the alumina particles containing silicon atoms and/or an inorganic silicon compound may be formed and used. Compared with flaky alumina particles containing silicon atoms and/or an inorganic silicon compound, flaky alumina particles that are a reaction product of the flaky alumina particles and an organosilane compound are preferable, because flaky alumina particles that are such a reaction product have a better affinity for a matrix because of the reaction of the silicon atoms and/or the inorganic silicon compound localized in the surface of the flaky alumina particles with the organosilane compound.

Examples of the organosilane compound include alkyl trimethoxysilanes and alkyl trichlorosilanes in which the alkyl group has 1 to 22 carbon atoms, such as methyltrimethoxysilane, dimethyldimethoxysilane, ethyltrimethoxysilane, ethyltriethoxysilane, propyitrimethoxysilane, n-propyltriethoxysilane, isopropyltrimethoxysilane, isopropyltriethoxysilane, pentyltrimethoxysilane, and hexyltrimethoxysilane, trimethoxy(3,3,3-trifluoropropyl)silane, (tridecafluoro-1,1,2,2-tetrahydrooctyl)trichlorosilane, phenyltrimethoxysilane, phenyltriethoxysilane, p-(chloromethyl)phenyltrimethoxysilane, p-(chloromethyl)phenyltriethoxysilane, epoxy silanes, such as γ-glycidoxypropyltrimethoxysilane, γ-glycidoxypropyltriethoxysilane, and β-(3,4-epoxycyclohexyl)ethyltrimethoxysilane, aminosilanes, such as γ-aminopropyltriethoxysilane, N-β-(aminoethyl)-γ-aminopropyltrimethoxysilane, N-β-(aminoethyl)-γ-aminopropylmethyldimethoxysilane, γ-aminopropyltrimethoxysilane, and γ-ureidopropyltriethoxysilane, mercaptosilanes, such as 3-mercaptopropyltrimethoxysilane, vinylsilanes, such as p-styryltrimethoxysilane, vinyltrichlorosilane, vinyltris(β-methoxyethoxy)silane, vinyltrimethoxysilane, vinyltriethoxysilane, and γ-methacryloxypropyltrimethoxysilane, and polymeric silanes, which may be epoxy-based, amino-based, or vinyl-based. Note that one of the organosilane compounds mentioned above may be present alone, or two or more thereof may be present.

It is sufficient that as a result of the reaction, the organosilane compound be covalently bound to at least a portion or the entirety of the silicon atoms and/or the inorganic silicon compound in the surface of the flaky alumina particles. Not only a portion of the alumina but also the entirety thereof may be covered with the reaction product. Methods that may be employed to provide the organosilane compound to the surface of the alumina include application by immersion and chemical vapor deposition (CVD)

An amount of usage of the organosilane compound, calculated as silicon atoms, is preferably less than or equal to 20 mass % and more preferably 10 to 0.01 mass %, relative to a mass of the silicon atoms and/or the inorganic silicon compound present in the surface of the flaky alumina particles. When the amount of usage of the organosilane compound is less than or equal to 20 mass %, the physical properties derived from the alumina particles can be easily exhibited, and, therefore, such an amount of usage is preferable.

The reaction between the organosilane compound and the alumina particles containing silicon atoms and/or an inorganic silicon compound can be accomplished by using any known, ordinary method for modifying a surface of a filler. For example, a spray process that uses a fluid nozzle, a dry method that uses stirring with shear force, a ball mill, a mixer, or the like, or a wet method that is, for example, aqueous-based or organic-solvent-based may be employed. Desirably, the process using shear force is to be performed in a manner such that the alumina particles to be used in embodiments are not broken.

A temperature in the system in the dry method or a post-treatment drying temperature in the wet method is to be appropriately specified in accordance with the type of the organosilane compound, such that the temperature is within a range that does not cause thermal decomposition of the organosilane compound. For example, in a case where a process is performed with an organosilane compound such as those mentioned above, the temperature is desirably 80 to 150° C.

### Resin Composition

In one embodiment, a resin composition including a resin and the composite particles of the above embodiment is provided. Examples of the resin include, but are not limited to, thermosetting resins and thermoplastic resins.

The resin composition can be cured to form a cured product of the resin composition. The resin composition can be cured and molded to form a molded article of the resin composition. For the molding, the resin composition may be appropriately subjected to one or more processes, such as melting and kneading. Examples of methods for the molding include compression molding, injection molding, extrusion molding, and foam molding. In particular, extrusion molding using an extrusion apparatus is preferable, and extrusion molding using a twin-screw extrusion apparatus is more preferable.

In a case where the resin composition is to be used as a coating agent, a coating formulation, or the like, a coating film having a cured product of the resin composition can be formed by applying the resin composition to an application target.

### Method for Producing Resin Composition

According to one embodiment of the present invention, a method for producing the resin composition is provided.

The production method includes a step of mixing a resin with the composite particles of the above embodiment. The flaky alumina particles to be used may be the flaky alumina particles described above, and, therefore, descriptions thereof are omitted here.

Note that the composite particles to be used may be ones that have undergone a surface treatment.

Furthermore, one type of composite particles may be used alone, or two or more types of composite particles may be used in combination.

Furthermore, the composite particles may be used in combination with one or more other fillers (e.g., fillers of alumina, spinel, boron nitride, aluminum nitride, magnesium oxide, and magnesium carbonate).

A content of the composite particles is preferably 5 to 95 mass %, more preferably 10 to 90 mass %, and even more preferably 30 to 80 mass %, relative to a total mass of the resin composition taken as 100 mass %. When the content of the composite particles is greater than or equal to 5 mass %, high thermal conductivity of the composite particles can be efficiently exhibited, and, therefore, such a content is preferable. On the other hand, when the content of the composite particles is less than or equal to 95 mass %, a resin composition having excellent moldability can be obtained, and, therefore, such a content is preferable. In a case where the resin composition is to be used as a coating agent, a coating formulation, or the like, it is preferable that the content of the composite particles be 0.1 to 95 mass % relative to a total mass on a solids basis of the resin composition taken as 100 mass %, from the standpoint of enabling excellent luminescent properties to be exhibited and facilitating the formation of a coating film; more preferably, the content is 1 to 50 mass %, and even more preferably, 3 to 30 mass %.

### Resin

Examples of the resin include, but are not limited to, thermoplastic resins and thermosetting resins.

The thermoplastic resins are not particularly limited, and any known, ordinary thermoplastic resin used as a molding material or the like may be used. Specific examples thereof include polyethylene resins, polypropylene resins, polymethylmethacrylate resins, polyvinyl acetate resins, ethylene-propylene copolymers, ethylene-vinyl acetate copolymers, polyvinyl chloride resins, polystyrene resins, polyacrylonitrile resins, polyamide resins, polycarbonate resins, polyacetal resins, polyethylene terephthalate resins, polyphenylene oxide resins, polyphenylene sulfide resins, polysulfone reins, polyethersulfone resins, polyetheretherketone resins, polyallyl sulfone resins, thermoplastic polyimide resins, thermoplastic urethane resins, polyamino bismaleimide resins, polyamide-imide resins, polyetherimide resins, bismaleimide triazine resins, polymethylpentene resins, fluorinated resins, liquid crystal polymers, olefin-vinyl alcohol copolymers, ionomer resins, polyarylate resins, acrylonitrile-ethylene-styrene copolymers, acrylonitrile-butadiene-styrene copolymers, and acrylonitrile-styrene copolymers.

The thermosetting resins are resins that have the property of being capable of changing to be substantially insoluble and non-meltable in instances in which the thermosetting resins are cured by means such as heating, use of radiation, use of a catalyst, or the like, and, typically, the thermosetting resins may be any known, ordinary thermosetting resins that are used as a molding material or the like. Specific examples thereof include phenolic resins, such as novolac-type phenolic resins and resole-type phenolic resins, examples of the novolac-type phenolic resins including phenol novolac resins and cresol novolac resins, examples of the resole-type phenolic resins including unmodified resole phenolic resin and oil-modified resole phenolic resins modified with Lung oil, linseed oil, walnut oil, or the like; epoxy resins, such as bisphenol-type epoxy resins, aliphatic chain-modified bisphenol-type epoxy resins, novolac-type epoxy resins, biphenyl-type epoxy resins, and polyalkylene glycol-type epoxy resins, examples of the bisphenol-type epoxy resins including bisphenol A epoxy resins and bisphenol F epoxy resins, examples of the novolac-type epoxy resins including novolac epoxy resins and cresol novolac epoxy resins; urea resins; triazine ring-containing resins, such as melamine resins; vinyl resins, such as (meth)acrylic resins and vinyl ester resins; unsaturated polyester resins; bismaleimide resins; polyurethane resins; diallyl phthalate resins; silicone resins; benzoxazine ring-containing resins; and cyanate ester resins.

One of the above-mentioned resins may be used alone, or two or more thereof may be used in combination. In this case, two or more thermoplastic resins may be used, two or more thermosetting resins may be used, or one or more thermoplastic resins and one or more thermosetting resins may be used.

A content of the resin is preferably 5 to 90 mass % and more preferably 10 to 70 mass %, relative to the total mass of the resin composition taken as 100 mass %. When the content of the resin is greater than or equal to 5 mass %, excellent moldability can be imparted to the resin composition, and, therefore, such a content is preferable. On the other hand, when the content of the resin is less than or equal to 90 mass %, a compound resulting from molding has high thermal conductivity, and, therefore, such a content is preferable.

### Curing Agent

The resin composition may include a curing agent mixed therewith as necessary.

The curing agent is not particularly limited and may be any known curing agent.

Specific examples thereof include amine-based compounds, amide-based compounds, acid anhydride-based compounds, and phenolic compounds.

Examples of the amine-based compounds include diaminodiphenylmethane, diethylenetriamine, triethylenetetramine, diaminodiphenyl sulfone, isophoronediamine, imidazole, BF-amine complexes, and guanidine derivatives.

Examples of the amide-based compounds include dicyandiamide and polyamide resins synthesized from a linolenic acid dimer and ethylenediamine.

Examples of the acid anhydride-based compounds include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride.

Examples of the phenolic compounds include phenol novolac resins, cresol novolac resins, aromatic hydrocarbon formaldehyde resin-modified phenolic resins, dicyclopentadiene phenol adduct-type resins, phenol aralkyl resins (xylok resins), polyphenolic novolac resins, typified by resorcinol novolac resins, that are synthesized from a polyhydroxy compound and formaldehyde, naphthol aralkyl resins, trimethylolmethane resins, tetraphenylolethane resins, naphthol novolac resins, naphthol-phenol co-condensed novolac resins, naphthol-cresol co-condensed novolac resins, biphenyl-modified phenolic resins (polyphenolic compounds in which phenol nuclei are interconnected by a bismethylene group), biphenyl-modified naphthol resins (polynaphtholic compounds in which phenol nuclei are interconnected by a bismethylene group), and polyhydric phenol compounds such as aminotriazine-modified phenolic resins (polyphenolic compounds in which phenol nuclei are interconnected by melamine, benzoguanamine, or the like) and alkoxy-group-containing aromatic ring-modified novolac resins (polyphenolic compounds in which phenol nuclei and alkoxy-group-containing aromatic rings are interconnected by formaldehyde).

One of the above-mentioned curing agents may be used alone, or two or more thereof may be used in combination.

### Curing Accelerator

The resin composition may include a curing accelerator mixed therewith as necessary.

The curing accelerator has a function of promoting curing when the composition is to be cured.

Examples of the curing accelerator include, but are not limited to, phosphorus-containing compounds, tertiary amines, imidazole, metal salts of an organic acid, Lewis acids, and amine complex salts.

One of the curing accelerators mentioned above may be used alone, or two or more thereof may be used in combination.

### Curing Catalyst

The resin composition may include a curing catalyst mixed therewith as necessary.

The curing catalyst has a function of, in place of the curing agent, advancing a curing reaction of an epoxy-group-containing compound.

Examples of the curing catalyst include, but are not limited to, known, ordinary thermal polymerization initiators and actinic radiation polymerization initiators.

Not that one curing catalyst may be used alone, or two or more curing catalysts may be used in combination.

### Viscosity Modifying Agent

The resin composition may include a viscosity modifying agent mixed therewith as necessary.

The viscosity modifying agent has a function of modifying a viscosity of the composition.

Examples of the viscosity modifying agent include, but are not limited to, organic polymers, polymer particles, and inorganic particles.

Note that one viscosity modifying agent may be used alone, or two or more viscosity modifying agents may be used in combination.

### Plasticizer

The resin composition may include a plasticizing agent mixed therewith as necessary.

The plasticizing agent has a function of improving the processability, flexibility, weatherability, and the like of a thermoplastic synthetic resin.

Examples of the plasticizing agent include, but are not limited to, phthalic acid esters, adipic acid esters, phosphoric acid esters, trimellitic acid esters, polyesters, polyolefins, and polysiloxanes.

Note that one of the plasticizing agents mentioned above may be used alone, or two or more thereof may be used in combination.

### Mixing Step

The resin composition of this embodiment can be obtained by mixing together the composite particles, a resin, and one or more other ingredients that may be added as necessary. Methods for the mixing are not particularly limited, and any known, ordinary method may be used for the mixing.

In a case where the resin is a thermosetting resin, a typical method for mixing together the thermosetting resin, the composite particles, and the like may be as follows. Predetermined amounts of the thermosetting resin, the composite particles, and one or more other ingredients that are added as necessary are mixed together thoroughly in a mixer or the like, and subsequently, the mixture is kneaded in a three-roll mill or the like to obtain a fluid, liquid composition. Furthermore, in another embodiment, a method for mixing together a thermosetting resin, the composite particles, and the like may be as follows. Predetermined amounts of the thermosetting resin, the composite particles, and one or more other ingredients that are added as necessary are mixed together thoroughly in a mixer or the like, and subsequently, the mixture is melt-kneaded in a mixing roll mill, an extrusion apparatus, or the like and then cooled to obtain a solid composition. Regarding a state of the mixing, in a case where a curing agent, a catalyst, and/or the like are added, it is sufficient that the additives and a curable resin be sufficiently homogeneously mixed with one another, but it is preferable that the composite particles be also uniformly dispersed and mixed therein.

In a case where the resin is a thermoplastic resin, a typical method for mixing together the thermoplastic resin, the composite particles, and the like may be as follows. The thermoplastic resin, the composite particles, and one or more other ingredients that are added as necessary are, for example, mixed together in advance using any of various types of mixers, such as a tumbler or a Henschel mixer, and subsequently, the mixture is melt-kneaded in a mixer, such as a Banbury mixer, a roll mill, a Brabender mixer, a single screw kneading and extrusion apparatus, a twin screw kneading and extrusion apparatus, a kneader, a mixing roll mill, or the like. Note that a temperature for the melt-kneading is not particularly limited and is typically within a range of 100 to 320° C.

A coupling agent may be added to the resin composition because a coupling agent enhances the fluidity and filling characteristics for fillers, such as the composite particles, of the resin composition. Note that adding a coupling agent further enhances adhesion between the resin and the composite particles and reduces interfacial thermal resistance between the resin and the composite particles, and, consequently, the thermal conductivity of the resin composition can be improved.

One coupling agent may be used alone, or two or more coupling agents may be used in combination.

An amount of addition of the coupling agent is not particularly limited and is preferably 0.01 to 5 mass % and more preferably 0.1 to 3 mass %, relative to a mass of the resin.

In one embodiment, the resin composition is used as a thermally conductive material.

Since the composite particles included in the resin composition exhibit excellent thermal conductivity for the resin composition, it is preferable that the resin composition be used as an insulating and heat dissipating member. Accordingly, heat dissipating properties of devices can be improved, and, therefore, a size and weight reduction and an enhancement in performance of devices can be achieved.

Since the composite particles included in the resin composition have excellent luminescent properties, the resin composition is suitable for use as a coating agent, a coating formulation, and the like.

### Method for Producing Cured Product

In one embodiment of the present invention, a method for producing a cured product is provided. The production method includes curing the resin composition produced as described above.

A temperature for the curing not particularly limited and is preferably 20 to 300° C. and more preferably 50 to 200° C.

A time for the curing is not particularly limited and is preferably 0.1 to 10 hours and more preferably 0.2 to 3 hours.

A shape of the cured product may vary depending on the desired application and may be appropriately designed by one skilled in the art.

In the resin composition, the method for producing the resin composition, and the cured product described above, the composite particles having a flaky shape are used; alternatively, composite particles having a polyhedral shape, which will be described below, may be used.

The inorganic coating described above is formed on flaky alumina particles; alternatively, the inorganic coating may be formed on polyhedral alumina particles. Specifically, the composite particles may have a polyhedral shape, that is, the composite particles may include alumina particles having a polyhedral shape and include an inorganic coating, which is disposed on a surface of the alumina particles and includes a composite metal oxide. In this case, a method for producing the composite particles may be similar to the above-described method for producing the composite particles except that a different method is used for the production of alumina particles having a polyhedral shape.

Alumina particles that are polyhedral particles can be easily loaded into the resin composition; in this regard, such alumina particles are advantageous. For example, in the flux method to be described in detail below, in a case where a molybdenum compound is used as a fluxing agent, polyhedral particles that are basically close to spherical particles can be obtained, and the polyhedral particles close to spherical particles are in an advantageous form because, when the particles are to be loaded into a resin composition, the loading can be easily accomplished. Specifically, the largest flat surface has an area less than or equal to one-eighth of the area of the structure, and in particular, particles in which the largest flat surface has an area less than or equal to one-sixteenth of the area of the structure can be suitably obtained.

Furthermore, presumably, in the case where alumina particles are polyhedral particles, when the particles come into contact with one another in a resin composition, surface-to-surface contact, which contributes to high thermal conductivity, occurs, and as a result, higher thermal conductivity can be achieved than in the case of spherical particles, provided that the filling ratios of the two cases are the same.

Furthermore, in a common flux method in which large amounts of a fluxing agent is used, the aluminum oxide that can be obtained has a hexagonal bipyramidal shape, that is, a shape having an acute angle, and, therefore, the aluminum oxide presents problems in that in a case where, for example, a resin composition that includes composite particles such as those of the embodiment is to be produced, damage is caused to a device, for instance. In contrast, the aluminum oxide used in this embodiment basically does not have a hexagonal bipyramidal shape and, therefore, is unlikely to cause problems such as damage to a device. In addition, since the aluminum oxide of this embodiment is basically a polyhedron having eight or more faces and thus has a shape close to a spherical shape, the aluminum oxide has a feature of being unlikely to cause problems such as damage to a device.

### EXAMPLES

The present invention will now be described in more detail with reference to examples. It should be noted that the present invention is not limited to the examples described below.

### Example 1

Flaky alumina, which was the body of the composite particles, was produced. A mixture was obtained by mixing together 100 g (65 mass %, calculated as an oxide (Al₂O₃)) of commercially available aluminum hydroxide (an average particle diameter of 1 to 2 μm), 6.5 g (9.0 mass %, calculated as an oxide (MoO₃)) of molybdenum trioxide (manufactured by Taiyo Koko Co., Ltd.), and 0.65 g (0.9 mass %, calculated as an oxide (SiO₂)) of silicon dioxide (special grade, manufactured by Kanto Chemical Co., Inc.) in a mortar. The resulting mixture was placed in a crucible, which was heated to 1200° C. under the condition of 5° C./min in a ceramic electric furnace and then held at 1200° C. for 10 hours. In this manner, firing was performed. Subsequently, the crucible was cooled to room temperature under the condition of 5° C./min and was then removed. Thus, 67.0 g of a light blue powder was obtained. The resulting powder was ground in a mortar until the particles could be passed through a 2-mm sieve.

Subsequently, 65.0 g of the obtained light blue powder was dispersed in 250 mL of 0.25% ammonia water, and the dispersion was stirred at room temperature (25 to 30° C.) for 3 hours. Subsequently, the resultant was passed through a 106-μm sieve, and filtration was performed to remove the ammonia water, which was followed by water washing and drying to remove molybdenum remaining on a surface of the particles. Thus, 60.0 g of a light blue powder was obtained. Accordingly, flaky alumina particles having a D₅₀ value of 28 μm were prepared.

SEM examination confirmed that the obtained powder had flaky alumina particles that had a polygonal flake shape and had very few aggregates and, therefore, had excellent handleability. In addition, when an XRD measurement was performed, a sharp scattering peak of α-alumina appeared, whereas peaks of alumina crystal systems other than the α-crystal structure were not observed. Accordingly, it was confirmed that flaky alumina having a dense crystal structure was obtained. In addition, from the results of a quantitative analysis of X-ray fluorescence, it was confirmed that the obtained particles contained molybdenum, which was calculated as molybdenum trioxide, in an amount of 0.61%.

Next, 15 g of the flaky alumina particles having a D₅₀ value of 28 μm was dispersed in 150 mL of water to obtain a dispersion. The pH of the dispersion was adjusted to 11.4 by using 1 mol of NaOH, and concurrently, a temperature of the dispersion was adjusted to be 65° C. While the dispersion was stirred, 100 g of a 14.1% CoSO₄ solution was added dropwise to the dispersion for 4.5 hours or less (theoretical coating ratio: 20). Concurrently, the pH of the dispersion was maintained at 11.4 by using 80 g of a 5% NaOH aqueous solution. After the dropwise addition of the CoSO₄ solution, the dispersion was stirred for another 4 hours, and the resulting dispersion was filtered and washed. Next, firing was performed at 1200° C. for 2 hours. Accordingly, 18.3 g of a powder of flaky alumina particles covered with cobalt oxide was obtained. The color of the composite particles was blue.

### Example 2

Flaky alumina particles having a D₅₀ value of 28 μm were prepared by using a production method similar to that for Example 1.

Furthermore, by using a production method similar to that for Example 1, 18.3 g of a powder of flaky alumina particles covered with cobalt oxide, which formed a first layer, was obtained.

Next, 5 g of the obtained powder was dispersed in 50 mL of water to obtain a dispersion. The pH of the dispersion was adjusted to 1.8 by using 1 mol of HCl, and concurrently, a temperature of the dispersion was adjusted to be 70° C. While the dispersion was stirred, 26.2 g of a 5% TiCl₄ solution was added dropwise to the dispersion for 2.5 hours or less (theoretical coating ratio: 10). Concurrently, the pH of the dispersion was maintained at 1.8 by using 47.3 q of a 5% NaOH aqueous solution. After the dropwise addition of the TiCl₄ solution, the dispersion was stirred for another 4 hours, and the resulting dispersion was filtered and washed. Next, firing was performed at 600° C. for 2 hours. Accordingly, 5.4 g of a sample of flaky alumina particles covered with aluminum-cobalt oxide and titanium oxide, which formed a second layer, was obtained. The color of the composite particles was blue.

### Example 3

Flaky alumina particles having a D₅₀ value of 28 μm were prepared by using a production method similar to that for Example 1.

In a manner similar to that for Example 2 except for the following differences, 5.4 g of a sample of flaky alumina particles covered with cobalt-iron oxide and iron oxide (III) was obtained. The differences were that for the formation of the first layer, 93.8 g of an 8.1% FeCl₃ solution was used, the time for dropwise addition of the FeCl₃ solution was 4.5 hours or less, and the pH of the dispersion was maintained at 2.7 by using 112.5 g of a NaOH aqueous solution; and for the formation of the second layer, 14.8 g of a 14.1% CoSO₄ solution was used, the time for dropwise addition of the CoSO₄ solution was 2.1 hours or less, the pH of the dispersion was maintained at 11.4 by using 11.9 g of a NaOH aqueous solution, and the firing temperature was changed to 700° C. The color of the composite particles was black.

### Example 4

Flaky alumina particles having a D₅₀ value of 28 μm were prepared by using a production method similar to that for Example 1.

In a manner similar to that for Example 3 except for the following differences, 5.4 g of a sample of flaky alumina particles covered with nickel-iron oxide was obtained. The differences were that for the formation of the second layer, 26.5 g of a 11.9% NiCl₂ solution was used, the time for dropwise addition of the NiCl₂ solution was 2 hours or less, and the pH of the dispersion was maintained at 10.5 by using 21.2 g of a NaOH aqueous solution. The color of the composite particles was brown.

### Example 5

Flaky alumina particles having a D₅₀ value of 28 μm were prepared by using a production method similar to that for Example 1.

In a manner similar to that for Example 3 except for the following differences, 5.5 g of a sample of flaky alumina particles covered with zinc-iron oxide and zinc oxide was obtained. The differences were that for the formation of the second layer, 15.6 g of a 11.9% ZnCl₂ solution was used, the time for dropwise addition of the ZnCl₂ solution was 2 hours or less, the pH of the dispersion was maintained at 7 by using 21.8 g of a NaOH aqueous solution, and the firing temperature was changed to 600° C. The color of the composite particles was light brown.

### Example 6

Flaky alumina particles having a D₅₀ value of 28 μm were prepared by using a production method similar to that for Example A.

In a manner similar to that for Example 2 except for the following differences, 5.4 g of a sample of flaky alumina particles covered with zinc-titanium oxide and zinc oxide was obtained. The differences were that for the formation of the first layer, 20 g of flaky alumina particles and 237.4 g of a 5% TiCl₄ solution was used, the time for dropwise addition of the TiCl₄ solution was 5.8 hours or less, and the pH of the dispersion was maintained at 1.8 by using 280.6 g of a NaOH aqueous solution; and for the formation of the second layer, 15.64 g of a 11.9% ZnCl₂ solution was used, the time for dropwise addition of the ZnCl₂ solution was 2 hours or less, and the pH of the dispersion was maintained at 7 by using 21.8 g of a NaOH aqueous solution. The color of the composite particles was white.

### Example 7

Flaky alumina particles having a D₅₀ value of 28 μm were prepared by using a production method similar to that for Example 1.

In a manner similar to that for Example 6 except for the following differences, 5.5 g of a sample of flaky alumina particles covered with cobalt-titanium oxide and an aluminum-cobalt oxide was obtained. The differences were that for the formation of the second layer, 14.8 g of a 14.1% CoSO₄ solution was used, the time for dropwise addition of the CoSO₄ solution was 2.1 hours or less, the pH of the dispersion was maintained at 11.4 by using 11.9 g of a NaOH aqueous solution, and the firing temperature was changed to 800° C. The color of the composite particles was light green.

### Example 8

Flaky alumina particles having a D₅₀ value of 28 μm were prepared by using a production method similar to that for Example 1.

In a manner similar to that for Example 6 except for the following differences, 5.0 g of a sample of flaky alumina particles covered with nickel-titanium oxide was obtained. The differences were that for the formation of the first layer, the time for dropwise addition of the TiCl₄ solution was 2.5 hours or less; and for the formation of the second layer, 2.7 g of a 11.9% NiCl₂ solution was used, the time for dropwise addition of the NiCl₂ solution was 0.25 hours or less, the pH of the dispersion was maintained at 10.5 b using 2.2 g of a NaOH aqueous solution, and the firing temperature was changed to 700° C. The color of the composite particles was light yellow.

### Example 9

Flaky alumina particles having a D₅₀ value of 28 μm were prepared by using a production method similar to that for Example 1.

In a manner similar to that for Example 8 except for the following differences, 5.2 g of a sample of flaky alumina particles covered with nickel-titanium oxide was obtained. The differences were that for the formation of the second layer, 14.1 g of the NiCl₂ solution was used, and the time for dropwise addition of the NiCl₂ solution was changed to 1 hour or less. The color of the composite particles was light yellow.

### Example 10

Flaky alumina particles having a D₅₀ value of 28 μm were prepared by using a production method similar to that for Example A.

In a manner similar to that for Example 8 except for the following differences, 5.5 g of a sample of flaky alumina particles covered with nickel-titanium oxide and nickel oxide was obtained. The differences were that for the formation of the second layer, 26.5 g of the NiCl₂ solution was used, and the time for dropwise addition of the NiCl₂ solution was changed to 2 hours or less. The color of the composite particles was light yellow.

### Example 11

Flaky alumina particles having a D₅₀ value of 28 μm were prepared by using a production method similar to that for Example 1.

In a manner similar to that for Example 8 except for the following differences, 6.2 g of a sample of flaky alumina particles covered with nickel-titanium oxide and nickel oxide was obtained. The differences were that for the formation of the first layer, 20 g of flaky alumina particles and 237.4 g of the TiCl₄ solution was used, and the time for dropwise addition of the TiCl₄ solution was changed to 5.8 hours or less; and for the formation of the second layer, 47.2 g of the NiCl₂ solution was used, and the time for dropwise addition of the NiCl₂ solution was changed to 3.4 hours or less. The color of the composite particles was yellow.

### Example 12

Flaky alumina particles having a D₅₀ value of 28 μm were prepared by using a production method similar to that for Example 1.

In a manner similar to that for Example 2 except for the following differences, 5.5 g of a sample of flaky alumina particles covered with aluminum-cobalt oxide and iron oxide (III) was obtained. The differences were that for the formation of the second layer, 13.9 g of an 8.1% FeCl₃ solution was used, the time for dropwise addition of the FeCl₃ solution was 2 hours or less, and the pH of the dispersion was maintained at 2.7 by using 16.7 g of a NaOH aqueous solution. The color of the composite particles was black.

### Example 13

Flaky alumina particles having a D₅₀ value of 28 μm were prepared by using a production method similar to that for Example 1.

In a manner similar to that for Example 1 except for the following differences, 17.6 g of a sample of flaky alumina particles covered with aluminum-zinc oxide was obtained. The differences were that for the formation of the first layer, 15.6 g of a 11.9% ZnCl₂ solution was used, the time for dropwise addition of the ZnCl₂ solution was 2.1 hours or less, and the pH of the dispersion was maintained at 2.7 by using 16.7 g of a NaOH aqueous solution. The color of the composite particles was white.

### Example 14

Flaky alumina particles having a D₅₀ value of 28 μm were prepared by using a production method similar to that for Example 1.

In a manner similar to that for Example 2 except for the following differences, 5.2 g of a sample of flaky alumina particles covered with manganese-iron oxide was obtained. The differences were that for the formation of the first layer, 5 g of flaky alumina particles and 34.1 g of a 8.1% FeCl₃ solution was used, the time for dropwise addition of the FeC₁₃ solution was 2.5 hours or less, the pH of the dispersion was maintained at 2.7 by using 41.0 g of a NaOH aqueous solution; and for the formation of the second layer, 12.65 g of a 10.0% MnCl₂·4H₂O solution was used, the time for dropwise addition of the MnCl₂·4H₂O solution was 1 hours or less, the pH of the dispersion was maintained at 8.0 by using 13.9 g of a NaOH aqueous solution, and the firing temperature was changed to 800° C. under a nitrogen atmosphere. The color of the composite particles was dark brown.

### Comparative Example 1

In a manner similar to that for Example 4 except for the following differences, 5.2 g of a sample of flaky alumina particles covered with iron oxide (III) and nickel oxide was obtained, by using the FeCl₃ solution for the formation of the first layer and using the NiCl₂ solution for the formation of the second layer. The differences were that commercially available alumina particles having a D₅₀ value of 30 μm (trade name A-SF-60, manufactured by Zhengzhou

Research institute of Chalco) were used; and for the formation of the first layer, the time for dropwise addition of the NiCl₂ solution was changed to 1.7 hours or less. The color of the composite particles was brown.

### Comparative Example 2

In a manner similar to that for Example 7 except for the following difference, 5.36 g of a sample of flaky alumina particles covered with cobalt oxide and titanium oxide was obtained, by using the TiCl₄ solution for the formation of the first layer and using the COSO₄ solution for the formation of the second layer. The difference was that the above-described commercially available alumina particles having a D₅₀ value of 30 μm were used. The color of the composite particles was light green.

### Comparative Example 3

In a manner similar to that for Example 5 except for the following difference, 5.0 g of a sample of polyhedral alumina particles covered with aluminum oxide and zinc oxide was obtained, by using the FeCl₃ solution for the formation of the first layer and using the ZnCl₂ solution for the formation of the second layer. The difference was that the above-described commercially available alumina particles having a D₅₀ value of 30 μm were used. The color of the composite particles was light brown.

### Comparative Example 4

In a manner similar to that for Example 6 except for the following difference, 5.4 g of a sample of polyhedral alumina particles covered with aluminum oxide and zinc oxide was obtained, by using the TiCl₄ solution for the formation of the first layer and using the ZnCl₂ solution for the formation of the second laver. The difference was that the above-described commercially available alumina particles having a D₅₀ value of 30 μm were used. The color of the composite particles was white.

### Comparative Example 5

In a manner similar to that for Example 9 except for the following difference, 4.7 g of a sample of polyhedral alumina particles covered with aluminum oxide was obtained, by using the TiCl₄ solution for the formation of the first layer and using the NiCl₂ solution for the formation of the second layer. The difference was that the above-described commercially available alumina particles having a D₅₀ value of 30 μm were used. The color of the composite particles was light yellow.

TABLE 1

| | | Example | Example | Example | Example | Example | Example | Example |
|---|---|---|---|---|---|---|---|---|
| | | 1 | 2 | 3 | 4 | 5 | 6 | 7 |
| Alumina | Alumina | | | | | | | |
| particles | Presence of surface Mo | Present | | | | | | |
| | Presence of surface Si | Present | | | | | | |
| | D₅₀ | 28 | | | | | | |
| | Thickness D | 400 nm | | | | | | |
| | Aspect ratio L/D | 32.5 | | | | | | |
| First layer | Coating material | CoO | CoO | Fe₂O₃ | Fe₂O₃ | Fe₂O₃ | TiO₂ | TiO₂ |
| coating | Time for dropwise addition | 4.5 | 4.5 | | | | | |
| conditions | of CoSO₄•7H₂O solution | | | | | | | |
| | (h) | | | | | | | |
| | Time for dropwise addition | | | 4.5 | 4.5 | 4.5 | | |
| | of FeCl₃ solution (h) | | | | | | | |
| | Time for dropwise addition | | | | | | 5.8 | 5.8 |
| | of TiCl₄ solution (h) | | | | | | | |
| | Temperature (° C.) | 65 | 65 | 75 | 75 | 75 | 70 | 70 |
| | pH | 11.4 | 11.4 | 2.7 | 2.7 | 2.7 | 1.8 | 1.8 |
| | Firing time (h, 1200° C.) | 2 | 2 | No firing | No firing | No firing | No firing | No firing |
| | Theoretical coating ratio | 20 | 20 | 20 | 20 | 20 | 20 | 20 |
| | (%, versus total) | | | | | | | |
| Second layer | Coating material | | TiO₂ | CoO | NiO | ZnO | ZnO | CoO |
| coating | Time for dropwise addition | | | 2.1 | | | | 2.1 |
| conditions | of CoSO₄•7H₂O solution | | | | | | | |
| | (h) | | | | | | | |
| | Time for dropwise addition | | | | | | | |
| | of FeCl₃ solution (h) | | | | | | | |
| | Time for dropwise addition | | 2.5 | | | | | |
| | of TiCl₄ solution (h) | | | | | | | |
| | Time for dropwise addition | | | | 2 | | | |
| | of NiCl₂•6H₂O solution | | | | | | | |
| | (h) | | | | | | | |
| | Time for dropwise addition | | | | | 2 | 2 | |
| | of ZnCl₂ solution (h) | | | | | | | |
| | Time for dropwise addition | — | — | — | — | — | — | — |
| | of MnCl₂•4H₂O solution | | | | | | | |
| | (h) | | | | | | | |
| | Temperature (° C.) | | 70 | 65 | 60 | 60 | 60 | 65 |
| | pH | | 1.8 | 11.4 | 10.5 | 7 | 7 | 11.4 |
| | Firing temperature (° C.) | | 600 | 700 | 700 | 600 | 600 | 800 |
| | Firing time (h) | | 2 | 2 | 2 | 2 | 2 | 2 |
| | Theoretical coating ratio | | 10 | 10 | 10 | 10 | 10 | 10 |
| | (%, versus total) | | | | | | | |
| Composite | Composition of inorganic | CoAl₂O₄ | CoAl₂O₄, | CoFe₂O₄, | NiFe₂O₄ | ZnFe₂O₄, | ZnTiO₃, | CoTiO₃, |
| particles | coating layer determined | | TiO₂ | Fe₂O₃ | | ZnO | ZnO | CoAl₂O₄ |
| | by XRD | | (rutile) | | | | | |
| | Evaluation | A | A | A | A | A | A | A |

TABLE 2

| | | Example | Example | Example | Example | Example | Example | Example |
|---|---|---|---|---|---|---|---|---|
| | | 8 | 9 | 10 | 11 | 12 | 13 | 14 |
| Alumina | Alumina | | | | | | | |
| particles | Presence of surface Mo | Present | | | | | | |
| | Presence of surface Si | Present | | | | | | |
| | D₅₀ | 28 | | | | | | |
| | Thickness D | 400 nm | | | | | | |
| | Aspect ratio L/D | 32.5 | | | | | | |
| First layer | Coating material | TiO₂ | TiO₂ | TiO₂ | TiO₂ | CoO | ZnO | Fe₂O₃ |
| coating | Time for dropwise addition | | | | | 4.5 | | — |
| conditions | of CoSO₄•7H₂O solution | | | | | | | |
| | (h) | | | | | | | |
| | Time for dropwise addition | | | | | | | 2.5 |
| | of FeCl₃ solution (h) | | | | | | | |
| | Time for dropwise addition | 2.5 | 2.5 | 2.5 | 5.8 | | | — |
| | of TiCl₄ solution (h) | | | | | | | |
| | Time for dropwise addition | | | | | | 2.1 | — |
| | of ZnCl₂ solution (h) | | | | | | | |
| | Temperature (° C.) | 70 | 70 | 70 | 70 | 65 | 80 | 65 |
| | pH | 1.8 | 1.8 | 1.8 | 1.8 | 11.4 | 7 | 2.7 |
| | Firing time (h, 1200° C.) | No firing | No firing | No firing | No firing | 2 | 2 | 2 |
| | Theoretical coating ratio | 10 | 10 | 10 | 20 | 20 | 10 | 20 |
| | (%, versus total) | | | | | | | |
| Second layer | Coating material | NiO | NiO | NiO | NiO | Fe₂O₃ | | MnO₂ |
| coating | Time for dropwise addition | | | | | | | — |
| conditions | of CoSO₄•7H₂O solution | | | | | | | |
| | (h) | | | | | | | |
| | Time for dropwise addition | | | | | 2 | | — |
| | of FeCl₃ solution (h) | | | | | | | |
| | Time for dropwise addition | | | | | | | — |
| | of TiCl₄ solution (h) | | | | | | | |
| | Time for dropwise addition | 0.25 | 1 | 2 | 3.4 | | | — |
| | of NiCl₂•6H₂O solution | | | | | | | |
| | (h) | | | | | | | |
| | Time for dropwise addition | | | | | | | — |
| | of ZnCl₂ solution (h) | | | | | | | |
| | Time for dropwise addition | — | — | — | — | — | — | 1 |
| | of MnCl₂•4H₂O solution | | | | | | | |
| | (h) | | | | | | | |
| | Temperature (° C.) | 60 | 60 | 60 | 60 | 75 | | 70 |
| | pH | 10.5 | 10.5 | 10.5 | 10.5 | 2.7 | | 8.0 |
| | Firing temperature (° C.) | 700 | 700 | 700 | 700 | 600 | | 800 |
| | Firing time (h) | 2 | 2 | 2 | 2 | 2 | | 2 |
| | Theoretical coating ratio | 1 | 5 | 10 | 20 | 10 | | 10 |
| | (%, versus total) | | | | | | | |
| Composite | Composition of inorganic | NiTiO₃ | NiTiO₃ | NiTiO₃, | NiTiO₃, | CoAl₂O₄, | ZnAl₂O₄ | MnFe₂O₄ |
| particles | coating layer determined | | | NiO | NiO | Fe₂O₃ | | |
| | by XRD | | | | | | | |
| | Evaluation | A | A | A | A | A | A | A |

TABLE 3

| | | Comparative | Comparative | Comparative | Comparative | Comparative |
|---|---|---|---|---|---|---|
| | | example 1 | example 2 | example 3 | example 4 | example 5 |
| Alumina | Alumina | Commercially available alumina | | | | |
| particles | Presence of surface Mo | Absent | | | | |
| | Presence of surface Si | Absent | | | | |
| | D₅₀ | 30 | | | | |
| | Thickness D | — | | | | |
| | Aspect ratio L/D | — | | | | |
| First layer | Coating material | Fe₂O₃ | TiO₂ | Fe₂O₃ | TiO₂ | TiO₂ |
| coating | Time for dropwise addition | | | | | |
| conditions | of CoSO₄•7H₂O solution | | | | | |
| | (h) | | | | | |
| | Time for dropwise addition | 4.5 | | 4.5 | | |
| | of FeCl₃ solution (h) | | | | | |
| | Time for dropwise addition | | 5.8 | | 5.8 | 2.5 |
| | of TiCl₄ solution (h) | | | | | |
| | Time for dropwise addition | | | | | |
| | of ZnCl₄ solution (h) | | | | | |
| | Temperature (° C.) | 75 | 70 | 75 | 70 | 70 |
| | pH | 2.7 | 1.8 | 2.7 | 1.8 | 1.8 |
| | Firing time (h, 1200° C.) | No firing | No firing | No firing | No firing | No firing |
| | Theoretical coating ratio | 20 | 20 | 20 | 20 | 10 |
| | (%, versus total) | | | | | |
| Second layer | Coating material | NiO | CoO | ZnO | ZnO | NiO |
| coating | Time for dropwise addition | | 2.1 | | | |
| conditions | of CoSO₄•7H₂O solution | | | | | |
| | (h) | | | | | |
| | Time for dropwise addition | | | | | |
| | of FeCl₃ solution (h) | | | | | |
| | Time for dropwise addition | | | | | |
| | of TiCl₄ solution (h) | | | | | |
| | Time for dropwise addition | 1.7 | | | | 1 |
| | of NiCl₂•6H₂O solution | | | | | |
| | (h) | | | | | |
| | Time for dropwise addition | | | 2 | 2 | |
| | of ZnCl₂ solution (h) | | | | | |
| | Temperature (° C.) | 60 | 60 | 60 | 60 | 60 |
| | pH | 10.5 | 11.4 | 7 | 7 | 10.5 |
| | Firing temperature (° C.) | 700 | 800 | 600 | 600 | 700 |
| | Firing time (h) | 2 | 2 | 2 | 2 | 2 |
| | Theoretical coating ratio | 10 | 10 | 18 | 18 | 10 |
| | (%, versus total) | | | | | |
| Composite | Composition of inorganic | Fe₂O₃, NiO | CoO, TiO₂ | Al₂O₃ + ZnO | Al₂O₃ + ZnO | Al₂O₃ |
| particles | coating layer determined | | | | | |
| | by XRD | | | | | |
| | Evaluation | B | B | B | B | B |

### Evaluation

The following evaluations were performed on the powders produced in Examples 1 to 14 and Comparative Examples 1 to 5, described above, which were used as test samples. The methods for the measurements are described below.

### Measurement of Major Dimension L of Alumina Particles

1 mg of the alumina powder was dispersed in a 0.2 wt % sodium hexametaphosphate aqueous solution (manufactured by FUJIFILM Wako Pure Chemical. Corporation) in a manner such that a total amount of the dispersion became 18 g. This was used as a sample, and a measurement was conducted on the sample by using a laser diffraction particle diameter analyzer (BALD-7000, manufactured by Shimadzu Corporation) Accordingly, the average particle diameter D₅₀ value (μm) was determined and designated as a major dimension L.

### Measurement of Thickness D of Alumina Particles

Thicknesses of 50 particles were measured by using a scanning electron microscope (SEM), and the average of the measurements was employed and designated as a thickness D (μm).

### Aspect Ratio LID

The aspect ratio was determined using the following equation.

(Aspect ratio)=major dimension L of alumina particles/thickness D of alumina particles)

### Analysis of Mo Content of Surface of Alumina Particles

The prepared test sample was pressed and secured to double-sided tape and was subjected to composition analysis, which was performed under conditions including the following, by using an X-ray photoelectron spectroscopy (XPS) instrument (Quantera SXM, manufactured by Ulvac-PHI, Inc.,).

X-ray source: monochromatic AlKα; a beam diameter of 100 μm φ; and an output of 25 W
Measurement: an analysis area of 1000 μm square; and n=3
Charge correction: C1s=284.8 eV

From the results of the XPS analysis, a [Mo]/[Al] value was determined, and the [Mo]/[Al] value was designated as a Mo content of the surface of the alumina particles. In cases where the Mo content was greater than or equal to 0.0005, it was determined that Mo was “present” in the surface of the alumina particles, and in cases where the Mo content was less than. 0.0005, it was determined that Mo was “absent” in the surface of the alumina particles.

### Evaluation of Coating

The obtained composite particles were placed and loaded into a measurement sample holder having a depth of 0.5 mm in a manner such that the composite particles were flattened under a given load. The sample holder was placed in a wide-angle X-ray diffractometer (Ultima IV (for XRD measurement), manufactured by Rigaku Corporation.), and a measurement was conducted under conditions including the following: Cu-Kα ratiation; 40 kV 40 mA; a scan speed of 2°/min.; and a scan range of 10 to 70°. The composition of the composite oxide layer was determined based on the obtained peak pattern. In the obtained composite particles, in cases where one or more composite metal oxides, which contained two or more metals, were present in the inorganic coating layer, a rating of A (“pass”) was given, and in cases where no composite metal oxide was present in the inorganic coating layer, a rating of B (“fail”) was given.

It was confirmed that the powders obtained in Examples 1 to 14 had the values of the particle diameter (D₅₀), the thickness, and the aspect ratio shown in Table 1 or Table 2. It was confirmed that the powders obtained in Comparative Examples 1 to 5 had the values of the particle diameter (D₅₀) shown in Table 3.

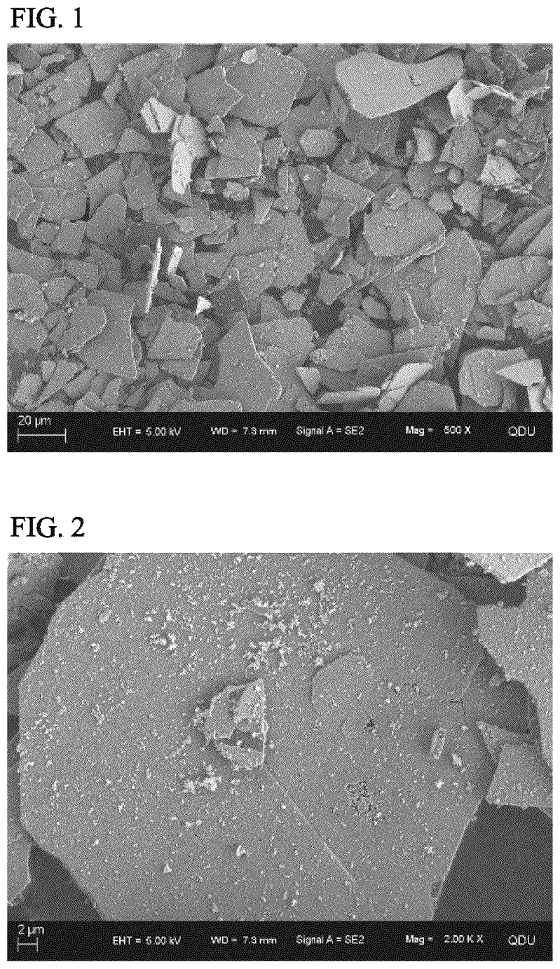

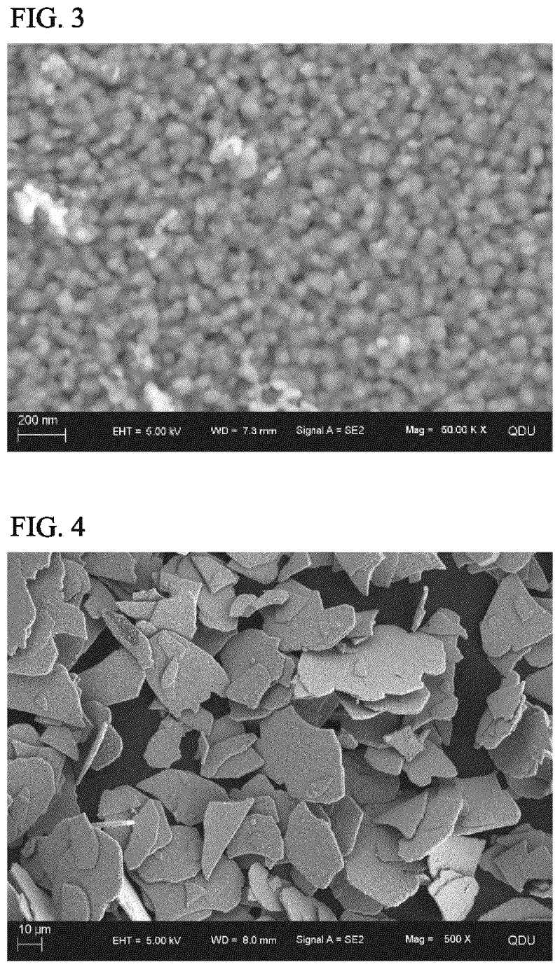

FIG. 1 to FIG. 3 show images of the flaky alumina particles of Example 3 obtained in SEM examination. The magnifications for FIG. 1, FIG. 2, and FIG. 3 are 500×, 2000×, and 50000×, respectively.

As shown in FIG. 1 to FIG. 3, it was confirmed that the surface of the flaky alumina of Example 3 was covered with particulate forms of cobalt-iron oxide (CoFe₂O₄) and iron oxide (III) (Fe₂O₃).

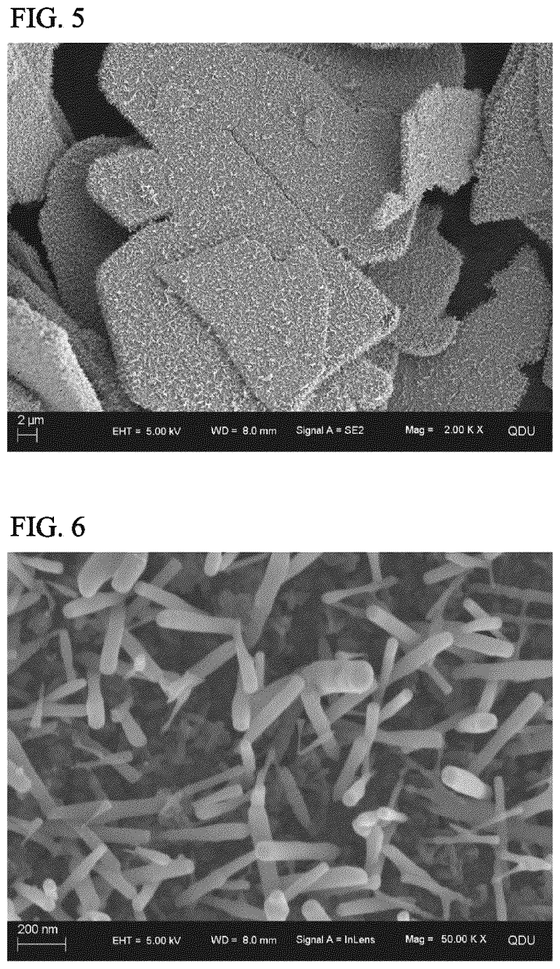

FIG. 4 to FIG. 6 show images of the flaky alumina particles of Example 6 obtained in SEM examination. The magnifications for FIG. 4, FIG. 5, and FIG. 6 are 500×, 2000×, and 50000×, respectively.

As shown in FIG. 4 to FIG. 6, it was confirmed that the surface of the flaky alumina of Example 6 was covered with particulate forms of zinc-titanium oxide (ZnTiO₃) and zinc oxide (ZnO).

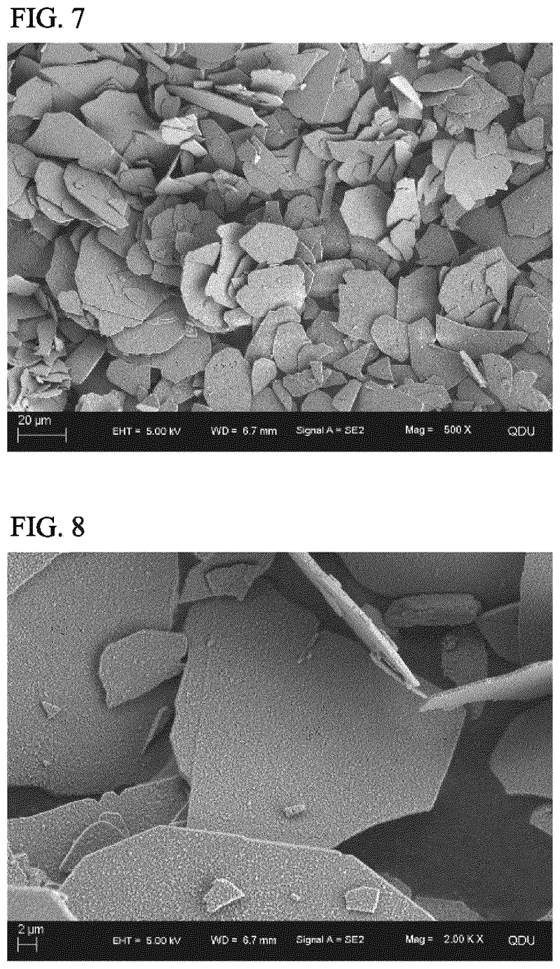

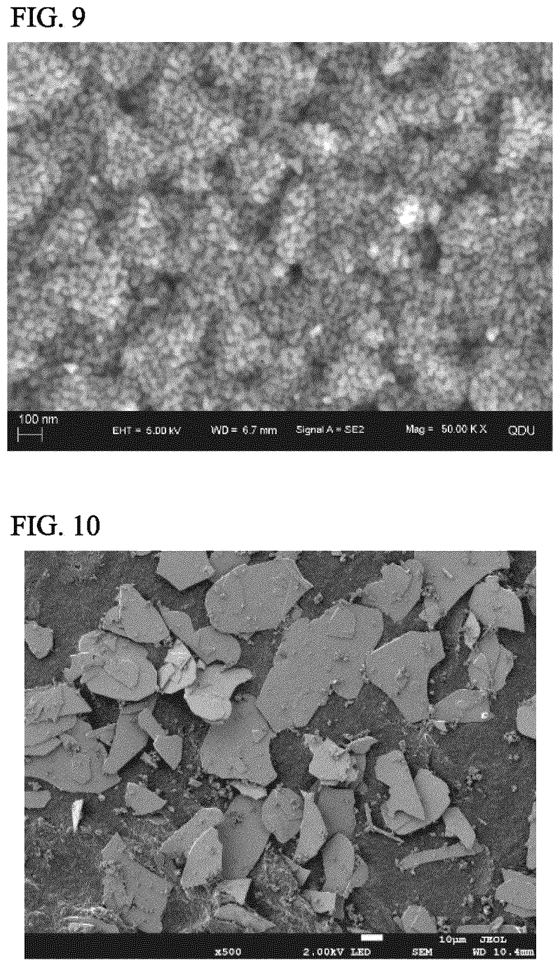

FIG. 7 to FIG. 9 show images of the flaky alumina particles of Example 12 obtained in SEM examination. The magnifications for FIG. 7, FIG. 8, and FIG. 9 are 500×, 2000×, and 50000×, respectively.

As shown in FIG. 7 to FIG. 9, it was confirmed that the surface of the flaky alumina of Example 12 was covered with particulate forms of aluminum-cobalt oxide (CoAl₂O₄) and iron oxide (III) (Fe₂O₃).

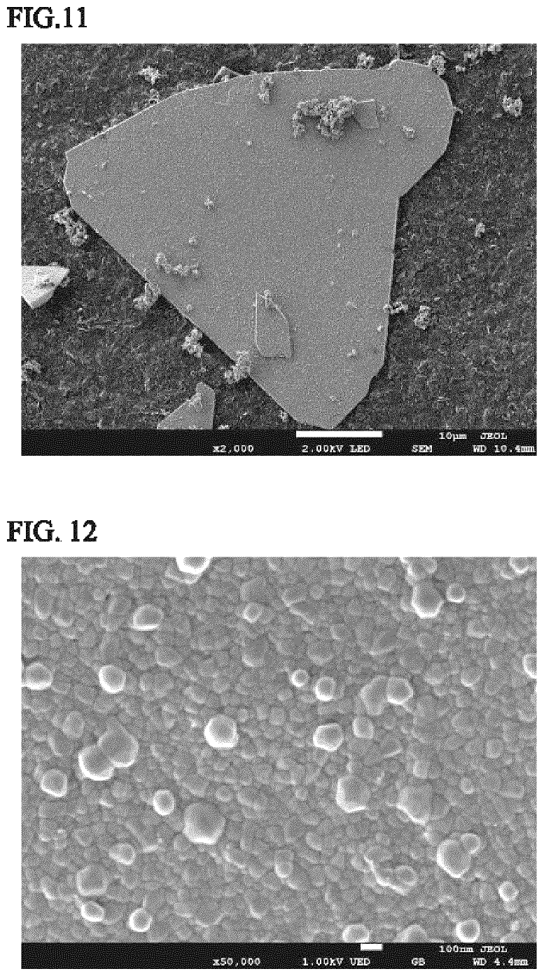

FIG. 10 to FIG. 12 show images of the flaky alumina particles of Example 14 obtained in SEM examination. The magnifications for FIG. 10, FIG. 11, and FIG. 12 are 500×, 2000×, and 50000×, respectively.

As shown in FIG. 10 to FIG. 12, it was confirmed that the surface of the flaky alumina of Example 14 was covered with particulate forms of manganese-iron oxide (MnFe₂O₄).

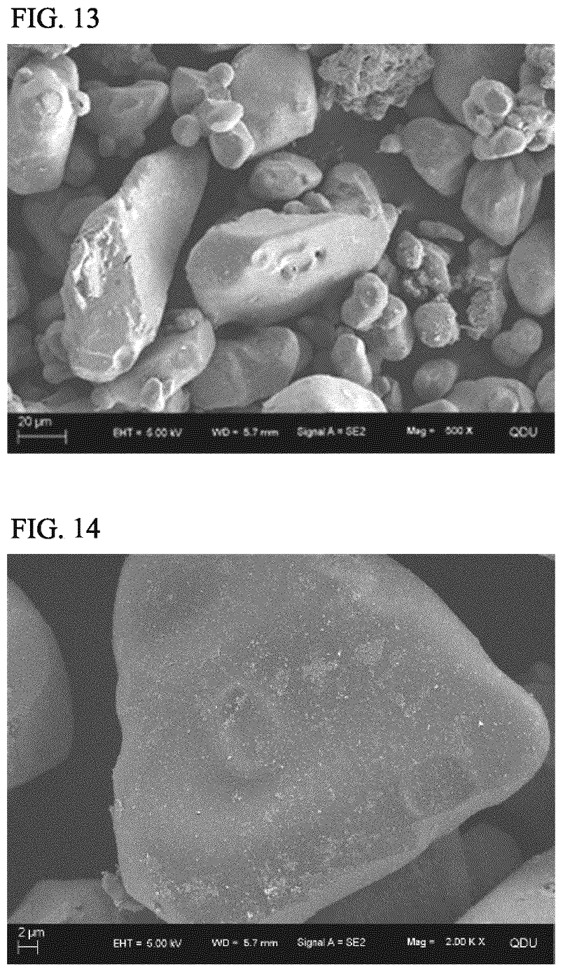

Furthermore, FIG. 13 to FIG. 15 show images of the flaky alumina particles of Comparative Example 1 obtained in SEM examination. The magnifications for FIGS. 13, 14, and

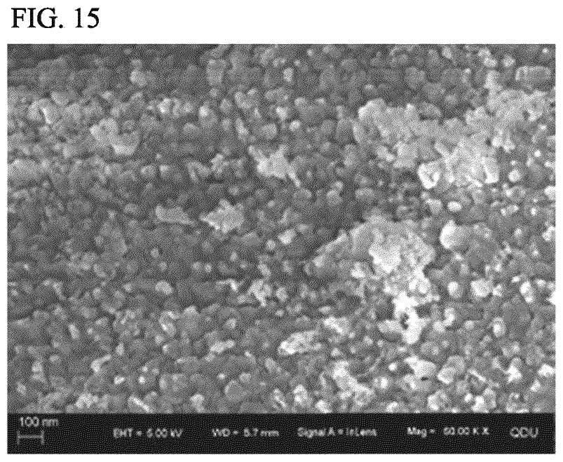

FIG. 15 are 500×, 2000×, and 50000×, respectively. As shown in FIG. 13 to FIG. 15, it was confirmed that the surface of the flaky alumina of Comparative Example 1 was covered with particulate forms of iron oxide (III) (Fe₂O₃) and nickel oxide (NiO).

Furthermore, in the composite particles of Examples 1 to 14, in which flaky alumina particles having a D₅₀ value of 28 μm were used, Mo and Si were confirmed to be present in the surface of the flaky alumina. In addition, in the inorganic coating layer of the composite particles obtained in each of the examples, the one or more composite metal oxides shown in Table 1 or Table 2 were present. Accordingly, it was discovered that when Mo is present in a surface of flaky alumina, an inorganic coating layer including a composite metal oxide can be formed on the flaky alumina. In particular, it was discovered that under the conditions of Examples 2 to 12, 14 the inorganic coating layer including the composite metal oxide shown in Table 1 or Table 2 can be formed at a relatively low firing temperature of 600 to 800° C. in the forming of the second layer.

On the other hand, in the composite particles of Comparative Example 1, in which commercially available flaky alumina particles having a 1) 5 value of 30 μm were used, the flaky alumina was confirmed to have an α crystal structure by the XRD measurement. Furthermore, neither Mo nor Si was confirmed to be present in the surface of the flaky alumina. In addition, although an inorganic coating layer formed of iron oxide (III) and nickel oxide was obtained, no inorganic coating layer including nickel-iron oxide was obtained.

In the composite particles of Comparative Example 2, in which commercially available flaky alumina particles having a D₅₀ value of 30 μm were used, the flaky alumina was confirmed to have an α crystal structure by the XRD measurement. Furthermore, neither No nor Si was confirmed to be present in the surface of the flaky alumina. In addition., although an inorganic coating layer formed of cobalt oxide and titanium oxide was obtained, no inorganic coating layer including cobalt-titanium oxide was obtained.

In the composite particles of Comparative Example 3, in which commercially available flaky alumina particles having a D₅₀ value of 30 μm were used, the flaky alumina was confirmed to have an α crystal structure by the XRD measurement. Furthermore, neither No nor Si was confirmed to be present in the surface of the flaky alumina. In addition, although an inorganic coating layer formed of aluminum oxide and zinc oxide was obtained, no inorganic coating layer including a zinc-iron oxide was obtained.

In the composite particles of Comparative Example 4, in which commercially available flaky alumina particles having a D₅₀ value of 30 μm were used, the flaky alumina was confirmed to have an α crystal structure by the XRD measurement. Furthermore, neither No nor Si was confirmed to be present in the surface of the flaky alumina. In addition, although an inorganic coating layer formed of aluminum oxide and zinc oxide was obtained, no inorganic coating layer including a zinc-titanium oxide was obtained.

In the composite particles of Comparative Example 5 in which commercially available flaky alumina particles having a D₅₀ value of 30 μm were used, the flaky alumina was confirmed to have an α crystal structure by the XRD measurement. Furthermore, neither No nor Si was confirmed to be present in the surface of the flaky alumina. In addition, although an inorganic coating layer formed of aluminum oxide was obtained, no inorganic coating layer including a nickel-titanium oxide was obtained.

### INDUSTRIAL APPLICABILITY

The composite particles of the present invention are particles in which alumina particles have high selectivity for coating materials, and, therefore, the composite particles are a material suitable for use in various fields. For example, the composite particles can be used in printing inks, coating formulations, automotive coatings, industrial coatings, thermally conductive fillers, cosmetic materials, abrasives, high-luminescent pigments, lubricants, base materials for conductive powders, ceramic materials, and the like.

1. Composite particles comprising alumina particles and an inorganic coating disposed on a surface of the alumina particles, the alumina particles containing molybdenum (Mo), the inorganic coating including a composite metal oxide.

2. The composite particles according to claim 1, wherein the composite metal oxide includes a metal oxide of two or more metals selected from iron (Fe), titanium (Ti), zinc (Zn), nickel (Ni), cobalt (Co), manganese (Mn), and aluminum (Al).

3. The composite particles according to claim 1, wherein the composite metal oxide includes a first metal oxide and a second metal oxide, the first metal oxide being a metal oxide of a metal selected from iron (Fe), titanium (Ti), zinc (Zn), nickel (Ni), and cobalt (Co), and manganese (Mn), the second metal oxide being a metal oxide of a metal selected from iron (Fe), titanium (Ti), zinc (Zn), nickel (Ni), and cobalt (Co), and manganese (Mn), the second metal oxide being different from the first metal oxide.

4. The composite particles according to claim 1, wherein the alumina particles further contain silicon (Si) and/or germanium (Ge).

5. The composite particles according to claim 4, wherein the alumina particles include mullite in a surface layer of the alumina particles.

6. The composite particles according to claim 1, wherein the composite particles have one of a flaky shape, a spherical shape, and a polyhedral shape.

7. The composite particles according to claim 1, wherein the composite particles have a flaky shape, a thickness of 0.01 pm or greater and 5 pm or less, an average particle diameter of 0.1 pm or greater and 500 pm or less, and an aspect ratio of 2 or greater and 500 or less.

8. A coating formulation, an ink, or a molded article comprising the composite particles according to claim 1.

9. A method for producing composite particles, the method comprising the steps of: producing alumina particles by sintering a mixture that includes an aluminum compound and a molybdenum compound, the aluminum compound containing elemental aluminum, the molybdenum compound containing elemental molybdenum, or by sintering a mixture that includes an aluminum compound, a molybdenum compound, and a shape control agent for controlling a shape of the alumina particles, the aluminum compound containing elemental aluminum, the molybdenum compound containing elemental molybdenum; and forming an inorganic coating on a surface of the alumina particles, the inorganic coating including a composite metal oxide.

10. The method for producing composite particles according to claim 9, wherein the shape control agent comprises one or more selected from silicon, a silicon compound, and a germanium compound, the silicon compound containing elemental silicon, the germanium compound containing elemental germanium.

11. The method for producing composite particles according to claim 9, wherein the mixture further includes a potassium compound containing elemental potassium.

12. The method for producing composite particles according to claim 9, wherein the composite metal oxide includes a metal oxide of two or more metals selected from iron (Fe), titanium (Ti), zinc (Zn), nickel (Ni), cobalt (Co), manganese (Mn), and aluminum (Al).

13. The method for producing composite particles according to claim 9, wherein the composite metal oxide includes a first metal oxide and a second metal oxide, the first metal oxide being a metal oxide of a metal selected from iron (Fe), titanium (Ti), zinc (Zn), nickel (Ni), and cobalt (Co), and manganese (Mn), the second metal oxide being a metal oxide of a metal selected from iron (Fe), titanium (Ti), zinc (Zn), nickel (Ni), and cobalt (Co), and Manganese (Mn), the second metal oxide being different from the first metal oxide.

14. The method for producing composite particles according to claim 9, wherein, in the forming of the inorganic coating, a metal inorganic salt containing at least one metal other than aluminum (Al) is contacted with the alumina particles, and then, the metal inorganic salt, which is deposited on the alumina particles, is converted into the composite metal oxide.

15. The method for producing composite particles according to claim 9, wherein the forming of the inorganic coating includes a first conversion step and a second conversion step, in the first conversion step, a first metal inorganic salt containing at least one metal other than aluminum (Al) is contacted with the alumina particles, and then, the first metal inorganic salt, which is deposited on the alumina particles, is converted into a metal oxide, and in the second conversion step, a second metal inorganic salt is contacted with the metal oxide and/or the alumina particles, the second metal inorganic salt containing at least one different metal, the different metal being a metal other than aluminum (Al) and different from the metal used in the first conversion step, and then, the metal oxide and/or the second metal inorganic salt are converted into the composite metal oxide.

16. The composite particles according to claim 2, wherein the composite particles have one of a flaky shape, a spherical shape, and a polyhedral shape.

17. The composite particles according to claim 3, wherein the composite particles have one of a flaky shape, a spherical shape, and a polyhedral shape.

18. The composite particles according to claim 2, wherein the composite particles have a flaky shape, a thickness of 0.01 pm or greater and 5 pm or less, an average particle diameter of 0.1 pm or greater and 500 pm or less, and an aspect ratio of 2 or greater and 500 or less.

19. A coating formulation, an ink, or a molded article comprising the composite particles according to claim 2.

20. The method for producing composite particles according to claim 10, wherein the mixture further includes a potassium compound containing elemental potassium.
